(19) United States
(12) Patent Application Publication
(10) Pub. No.: US 2017/0153455 A1
(43) Pub. Date: Jun. 1, 2017

(54) DECENTERED OPTICAL SYSTEM, AND IMAGE PROJECTOR APPARATUS INCORPORATING THE DECENTERED OPTICAL SYSTEM

(71) Applicant: OLYMPUS CORPORATION, Tokyo (JP)

(72) Inventor: Koichi TAKAHASHI, Tokyo (JP)

(73) Assignee: OLYMPUS CORPORATION, Tokyo (JP)

(21) Appl. No.: 15/432,577

(22) Filed: Feb. 14, 2017

Related U.S. Application Data
(63) Continuation of application No. PCT/JP2014/078386, filed on Oct. 24, 2014.

(51) Int. Cl. G02B 27/01; G02B 5/18; G02B 27/00

(52) U.S. Cl. CPC G02B 27/0172; G02B 27/0025; G02B 5/189; G02B 2027/0178; G02B 2027/013; G02B 2027/0116

(57) ABSTRACT

The decentered optical system 1 includes:
a first optical element 10 having at least three mutually decentered optical surfaces, and filled inside with a medium having a refractive index of greater than 1, at least one of the three optical surfaces being configured into a rotationally asymmetric shape,
a second optical element 20 having at least two mutually decentered optical surfaces, and filled inside with a medium having a refractive index of greater than 1, and
a third optical element 30 having at least two mutually decentered optical surfaces, and filled inside with a medium having a refractive index of greater than 1.

### CROSS-REFERENCE TO RELATED APPLICATIONS

This application is based on PCT/JP2014/078386 filed on Oct. 24, 2014. The content of the Japan Application is incorporated herein by reference.

### BACKGROUND OF THE INVENTION AND RELATED ART STATEMENT

The present invention relates to a decentered optical system having decentered optical surfaces, and an image projector apparatus incorporating that decentered optical system.

So far there has been an image projector apparatus known in the art, in which small-format image display devices are used to enlarge original images from these image display devices through an optical system for projection. There is now a mounting demand for the image projector apparatus to reduce in terms of the size and weight of the overall apparatus for the purpose of achieving improved portability. For presentation of images, there is also a demand for an image optical system capable of enlarging original images from the display devices to a certain magnitude and projecting them at a wider angle of view for the purpose of high resolution expression. Among means proposed so far in the art to satisfy such demands there is a system known in which a projecting optical system has a prism decentered with respect to the visual axis of a viewer so that enlarged virtual images can be projected from image display devices.

For instance, JP(A) 2010-92061 discloses an image projector provided with a prism having a hologram element, and JP(A) 3-101709 discloses an apparatus in which a concave surface adapted to reflect infrared rays alone is located outside of and away from a reflective surface defined by a concave surface to detect the line of sight of a user.

### SUMMARY OF INVENTION

According to one embodiment, a decentered optical system includes:

a first optical element having at least three mutually decentered optical surfaces: a first surface capable of light transmission, a second surface capable of light transmission and internal reflection, and a third surface capable of light transmission and internal reflection, and filled inside with a medium having a refractive index of greater than 1, at least one of the three optical surfaces being configured into a rotationally asymmetric shape,

a second optical element having at least two mutually decentered optical surfaces: a first surface that is capable of light transmission and located facing the first optical element, and a second surface that is capable of light transmission, located in opposition to the first optical element and defined by a plane, and filled inside with a medium having a refractive index of greater than 1, the second optical element being located on a second surface side of the first optical element, and

a third optical element having at least two mutually decentered optical surfaces: a first surface that is capable of light transmission, located in opposition to the first optical element and defined by a plane, and a second surface that is capable of light transmission and cemented to the third surface of the first optical element, and filled inside with a medium having a refractive index of greater than 1.

According to one embodiment, an image projector apparatus includes:

the aforesaid decentered optical system, and

an image display device that is located in a position in opposition to the first surface of the first optical element.

### BRIEF DESCRIPTION OF DRAWINGS

FIG. 1 is a sectional view of the decentered optical system according to one embodiment.

FIG. 2A-2F are illustrative of the diffractive optical surface of the diffractive optical system according to one embodiment of the invention.

FIG. 3 is illustrative of an exemplary diffractive optical surface formed by the lamination of a plurality of optical members according to one embodiment.

FIG. 4 is a sectional view of the decentered optical system of Example 1 including its center chief ray.

FIG. 5 is a plan view of the decentered optical system of Example 1.

FIG. 6 is an aberrational diagram for the decentered optical system of Example 1.

FIG. 7 is an aberrational diagram for the decentered optical system of Example 1.

FIG. 8 is a sectional view of the decentered optical system of Example 1 including the center chief ray of a direct-vision optical path.

FIG. 9 is a plan view of the direct-vision optical path taken through the decentered optical system of Example 1.

FIG. 10 is an aberrational diagram for the direct-vision optical path taken through the decentered optical system of Example 1.

FIG. 11 is an aberrational diagram for the direct-vision optical path taken through the decentered optical system of Example 1.

FIG. 12 is a sectional view of the decentered optical system of Example 2 including its center chief ray.

FIG. 13 is a plan view of the decentered optical system of Example 2.

FIG. 14 is an aberrational diagram for the de-centered optical system of Example 2.

FIG. 15 is an aberrational diagram for the de-centered optical system of Example 2.

FIG. 16 is a sectional view of the decentered optical system of Example 2 including the center chief ray of a direct-vision optical path.

FIG. 17 is a plan view of the direct-vision optical path taken through the decentered optical system of Example 2.

FIG. 18 is an aberrational diagram for the direct-vision optical path taken through the decentered optical system of Example 2.

FIG. 19 is an aberrational diagram for the direct-vision optical path taken through the decentered optical system of Example 2.

FIG. 20 is a sectional view of the decentered optical system of Example 3 including its center chief ray.

FIG. 21 is a plan view of the decentered optical system of Example 3.

FIG. 22 is an aberrational diagram for the de-centered optical system of Example 3.

FIG. 23 is an aberrational diagram for the de-centered optical system of Example 3.

FIG. 24 is a sectional view of the decentered optical system of Example 3 including the center chief ray of a direct-vision optical path.

FIG. 25 is a plan view of the direct-vision optical path taken through the decentered optical system of Example 3.

FIG. 26 is an aberrational diagram for the direct-vision optical path taken through the decentered optical system of Example 3.

FIG. 27 is an aberrational diagram for the direct-vision optical path taken through the decentered optical system of Example 3.

FIG. 28 is a sectional view of the decentered optical system of Example 4 including its center chief ray.

FIG. 29 is a plan view of the decentered optical system of Example 4.

FIG. 30 is an aberrational diagram for the decentered optical system of Example 4.

FIG. 31 is an aberrational diagram for the decentered optical system of Example 4.

FIG. 32 is a sectional view of the decentered optical system of Example 4 including the center chief ray of a direct-vision optical path.

FIG. 33 is a plan view of the direct-vision optical path taken through the decentered optical system of Example 4.

FIG. 34 is an aberrational diagram for the direct-vision optical path taken through the decentered optical system of Example 4.

FIG. 35 is an aberrational diagram for the direct-vision optical path taken through the decentered optical system of Example 4.

FIG. 36 is illustrative of an image projector apparatus in which the decentered optical system according to one embodiment is built in eyeglasses for use.

### DESCRIPTION OF EMBODIMENTS

The decentered optical system according to one specific embodiment and an exemplary image projector apparatus incorporating that decentered optical system are now explained with reference to the accompanying drawings.

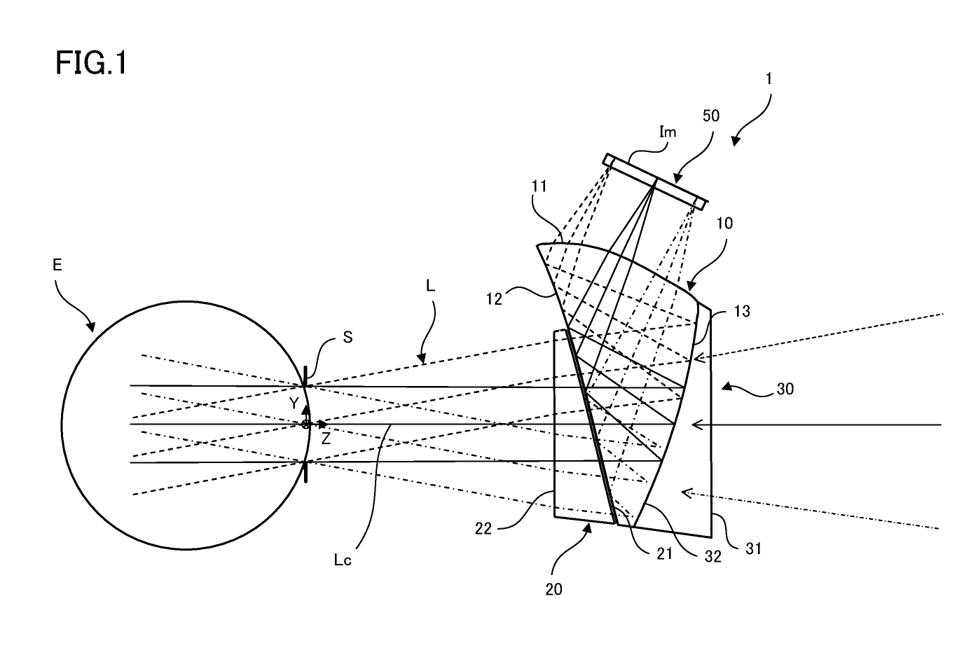

FIG. 1 is a sectional view of the decentered optical system according to one embodiment.

A specific decentered optical system shown generally by 1 preferably comprises, in combination, a first optical element 10 having at least three mutually decentered optical surfaces: a first surface 11 capable of light transmission, a second surface 12 capable of light transmission and reflection, and a third surface 13 capable of light transmission and reflection, and filled inside with a medium having a refractive index of greater than 1, at least one of the three optical surfaces being configured into a rotationally asymmetric shape, a second optical element 20 having at least two mutually decentered optical surfaces: a first surface 11 that is located facing the second surface 12 of the first optical element 10 and capable of light transmission and a second surface 12 that is capable of light transmission and defined by a plane, and filled inside with a medium having a refractive index of greater than 1, and a third optical element 30 having at least two mutually decentered optical surfaces: a first surface 31 that is located facing the third surface 13 of the first optical element 31 and defined by a plane and a second surface 32 that is cemented to the third surface 13 of the first optical element 10 and capable of light transmission, and filled inside with a medium having a refractive index of greater than 1.

The merits ensuing from such arrangement of the decentered optical system 1 are here explained.

First of all, the decentered optical system 1 according to the embodiment here makes use of the first optical element 10 including at least three mutually de-centered optical surfaces: the first optical surface 11 capable of light transmission, the second optical surface 12 capable of light transmission and reflection, and the third optical surface 13 capable of light transmission and internal reflection, and filled inside with a medium having a refractive index of greater than 1, whereby it is possible to have an internal reflection optical path defined by the decentered prism and prevent images for viewing or taken images from having chromatic aberrations. It is also possible to prevent any increase in the count of optical elements for correction of chromatic aberrations. The optical path involved is so folded up by reflection that the optical system itself can be smaller relative to dioptric systems.

In the first optical element 10, at least one of the three optical surfaces has a rotationally asymmetric configuration that is preferable for giving optical power to light beams and correction of decentration aberrations as well.

By use of the second optical element 20 that is located on the second surface 12 side of the first optical element 10, includes at least two mutually decentered surfaces: the first surface 21 capable of light transmission and the second surface 22 capable of light transmission and defined by a plane, and is filled inside with a medium having a refractive index of greater than 1, the second optical element 20 could be made up of two mutually decentered surfaces so that the opposite surfaces of both the first 10 and second element 20 can be closely located and configured in an approximate shape. The second planar surface 22 of the second optical element 20 could be located in a position that faces the eyeball of a viewer (the entrance pupil (stop) in the case of a taking optical system) on the optical axis, forming a planar configuration with respect to the eye. Therefore, two such surfaces could be modified to reduce aberrations occurring from them in favor of a wider field-of-view arrangement. The planar form of the second surface 22 of the second optical element 20 is easy to process, not only resulting in cost reductions but also making it possible for power to become zero with respect to external light, allowing for viewing of unaffected external images.

Further by use of the third optical element 30 that is located on the third surface 13 side of the first optical element 10, includes at least two mutually de-centered surfaces: the first surface 31 capable of light transmission and having a plane on its outside and the second surface 32 that is capable of light transmission and cemented to the third surface 13 of the first optical element 10, and is filled inside with a medium having a refractive index of greater than 1, it is possible for combined power to get small (or preferably gets down to nearly to zero), enabling the viewer to view unaffected optical see-through images having no or little distortion at a nearly 1 magnification.

Reference is then made to ray tracing in the case of using the decentered optical system 1 with an image projector apparatus. Light rays, exiting out from an image plane Im defined as the display surface of an image display device 50, enter the first optical element 10 from the first surface 11, and are reflected at the second surface 12. The light rays reflected at the second surface 12 are further reflected at the third surface 13, exiting out from the first optical element 10 via the second surface 12. The light rays exiting out from the first optical element 10 enter the second optical element 20 from the first surface 21, exiting out from the second surface 22. The light rays exiting out from the second element 20 pass through an aperture stop S acting as an exit pupil for projection onto the pupil E of the viewer.

Referring to a direct-vision optical path taken through the decentered optical system 1, light rays exiting out from an image plane (not shown) enter the third optical element 30 from the first surface 31, exiting out from the second surface 32. The light rays exiting out from the third optical element 30 enter the first optical system 10 from the third surface 13, exiting out from the second surface 12. The light rays exiting out from the first optical element 10 enter the second optical element 20 from the first surface 21, exiting out from the second surface 22. The light rays exiting out from the second optical element 20 pass through the aperture stop S acting as an exit pupil for projection onto the pupil E of the viewer.

According to the decentered optical system 1 of the embodiment described here, it is thus possible to project or take images in high resolutions albeit having a small-format and simple structure.

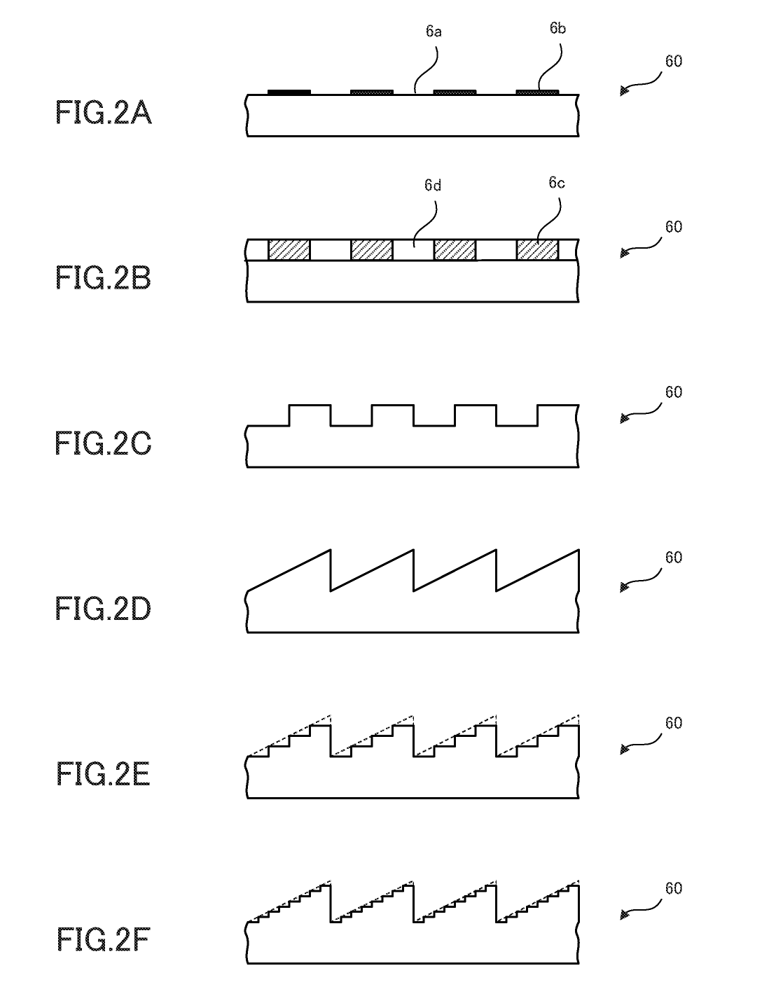

FIG. 2a-2F are illustrative of the diffractive optical surface of the decentered optical system according to one embodiment.

The decentered optical system 1 described here preferably comprises a diffractive optical surface 60 in an optical path taken from an object plane to an image plane. Such provision of the diffractive optical surface 60 in the optical path from the object plane to the image plane allows for correction of chromatic aberrations. The diffractive optical surface 60 may be formed of a material such as low-melting glass or thermoplastic resin.

For the diffractive optical surface 6, use may be made of, for instance, a Fresnel zone plate, a kinoform, a binary optics, and a hologram. The diffractive optical surface 60 shown typically in FIG. 2A is of the amplitude-modulated type wherein transparent portions 6a and opaque portions 6b that appear alternately with each opaque portions 6b having a thickness of nearly zero. The diffractive optical surface 60 shown in FIG. 2B includes portions having different refractive indices: high-refractive-index portions 6c and low-refractive-index portions 6d that are alternately arranged to enable it to have diffraction due to a phase difference resulting from a refractive index difference. The diffractive optical surface 60 shown in FIG. 2C includes rectangular recesses and projections that are alternately arranged to enable it to have diffraction due to a phase difference resulting from a thickness difference. The diffractive optical surface 60 shown in FIG. 2D—called a kinoform—is serrated thereon to enable it to have diffraction due to a phase difference resulting from a continuous thickness difference. FIGS. 2E and 2F are binary elements in which the kinoform is approximated in four and eight stages, respectively.

Also, the decentered optical system 1 described here preferably comprises on the outside of the first surface 11 of the first optical element 10 a diffractive optical element 61 having a diffractive optical surface 60. Provision of the diffractive optical element 61 on the outside of the first surface 11 of the first optical element 10 makes the angle of incidence less variable so that the diffraction effect of the diffractive optical element 61 can become uniform within the pupil plane.

In the decentered optical system 1 described here, the diffractive optical surface 60 is preferably defined or formed on the second surface 22 of the second optical element 20. Forming the diffractive optical surface 60 on the second surface 22 of the second optical element 20 contributes more to correction of aberrations by diffraction without increasing an optical elements count.

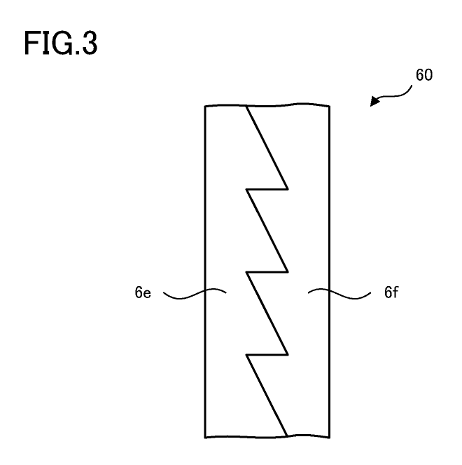

FIG. 3 is illustrative of the decentered optical system according to one embodiment wherein the diffractive optical surface is formed of a plurality of optical members laminated one upon another.

The diffractive optical surface 60 is preferably formed by lamination of a plurality of optical members 6e, 6f having different refractive indices. The optical members 6e, 6f are each formed of one plane and another kinoform plane, and the kinoform planes of both are combined into the diffractive optical surface 60. Lamination of a plurality of optical members 6e, 6f having different refractive indices could prevent light of unnecessary orders from occurring depending on wavelength as compared with an ordinary diffractive optical element, resulting in higher resolving power.

In the decentered optical system described here, the second surface 12 of the first optical element 10 is preferably spaced away from the first surface 21 of the second optical element 20. Spacing the second surface 12 of the first optical element 10 away from the first surface 21 of the second optical element 20 allows for internal reflection at the second surface 12 of the first optical element 10 to occur in the form of total reflection.

In the decentered optical system 1 described here, the second surface 12 of the first optical element 10 and the first surface 21 of the second optical element 20 are preferably of the same surface configuration in an effective area. The second surface 12 of the first optical element 10 being the same in shape as the first surface 21 of the second optical element 20 makes it possible to hold back the occurrence of aberrations.

In the decentered optical system 1 described here, the second surface 12 of the first optical element 10 is preferably in a rotationally asymmetric configuration. The second surface 12 of the first optical element 10, because of having two optical actions: internal reflection and light transmission is going to have two corrections of aberrations. As is the case with the third surface, this surface has a large action on correction of aberrations inclusive of decentration aberration and, hence, makes a lot of contributions to improvements in the optical performance of the entire optical system.

In the decentered optical system described here, the refracting power of the whole optical system with respect to a center chief ray Lc incident on the first surface 31 of the third optical element 30 preferably satisfies the following condition (1):

−0.05<φg<0.05 (1)

where the refracting power φg of the whole optical system is represented by φg=1/fg with the proviso that fg is a focal length of the whole optical system.

This condition is required for a viewer to use the present optical system to view unaffected external images. As the upper limit of condition (1) is exceeded, it gives rise to an increase in the power of the optical system with respect to external light. As a result, diopter becomes plus, bringing external images out of focus and making them hard to look at. As the lower limit of condition (1) is not reached, it gives rise to an increase in the power of the optical system in a negative direction. In turn, diopter becomes minus, rendering focusing difficult and resulting in burdens on the viewer or the inability to view external images.

Each example of one embodiment will now be explained.

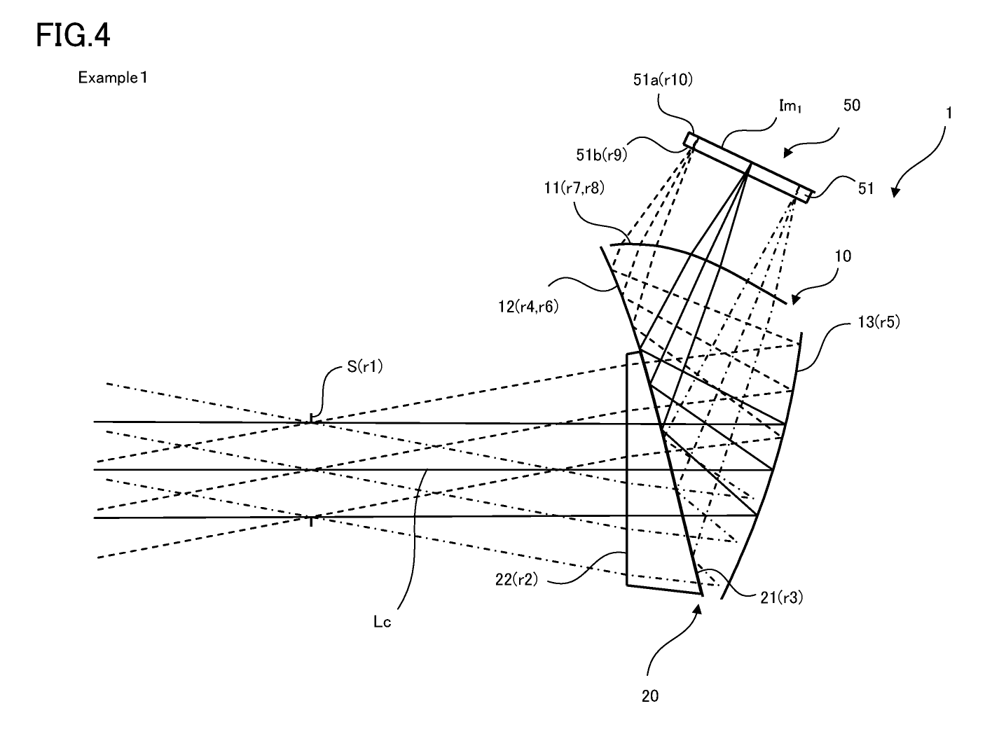

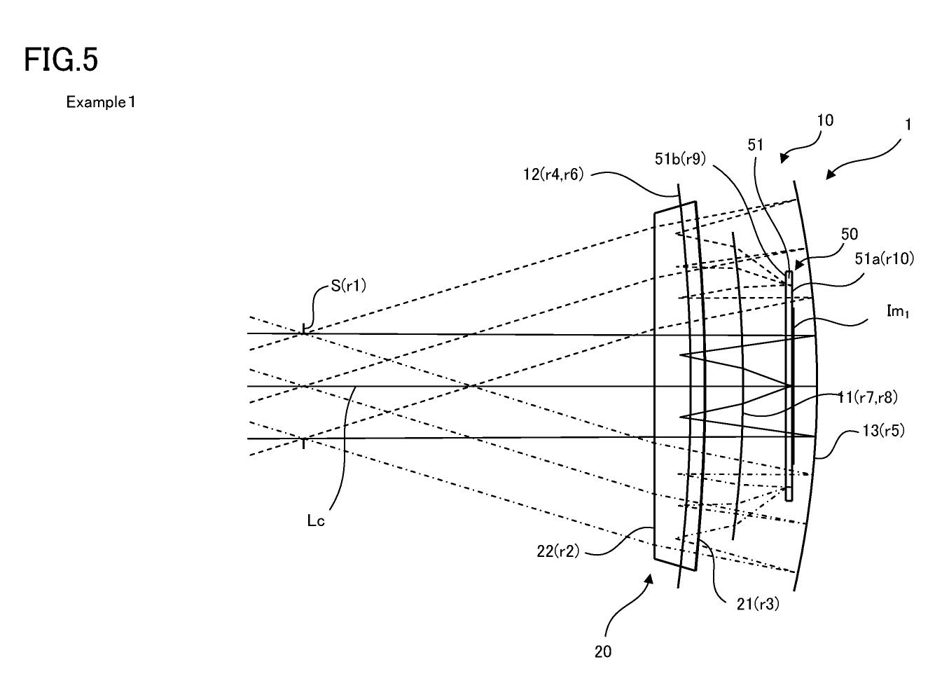

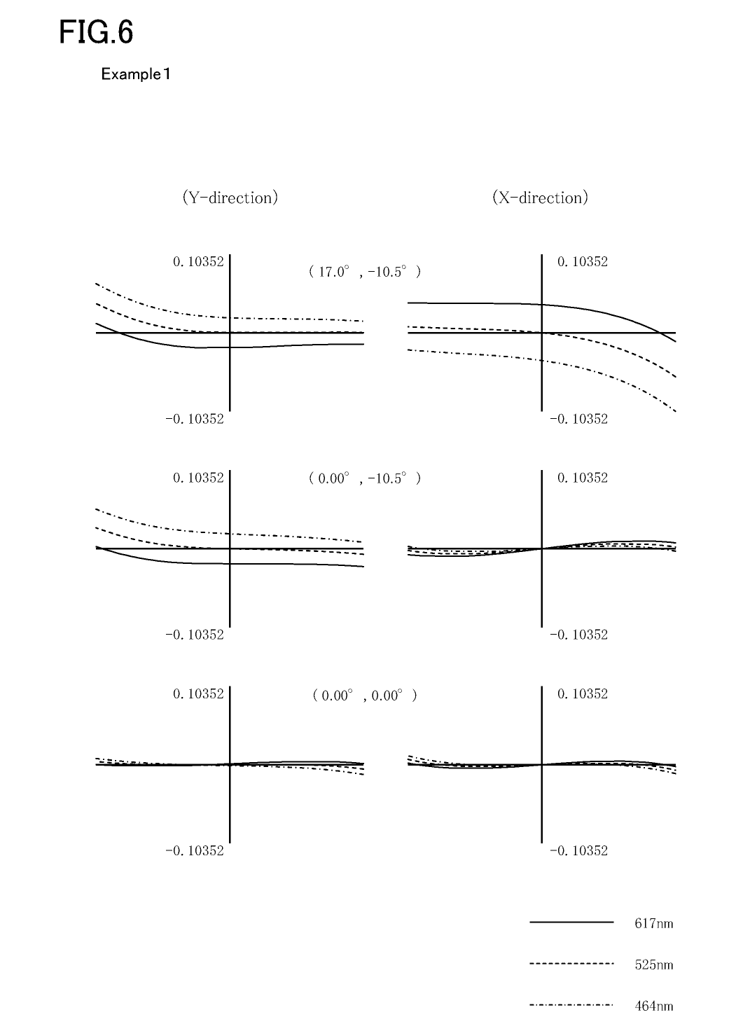

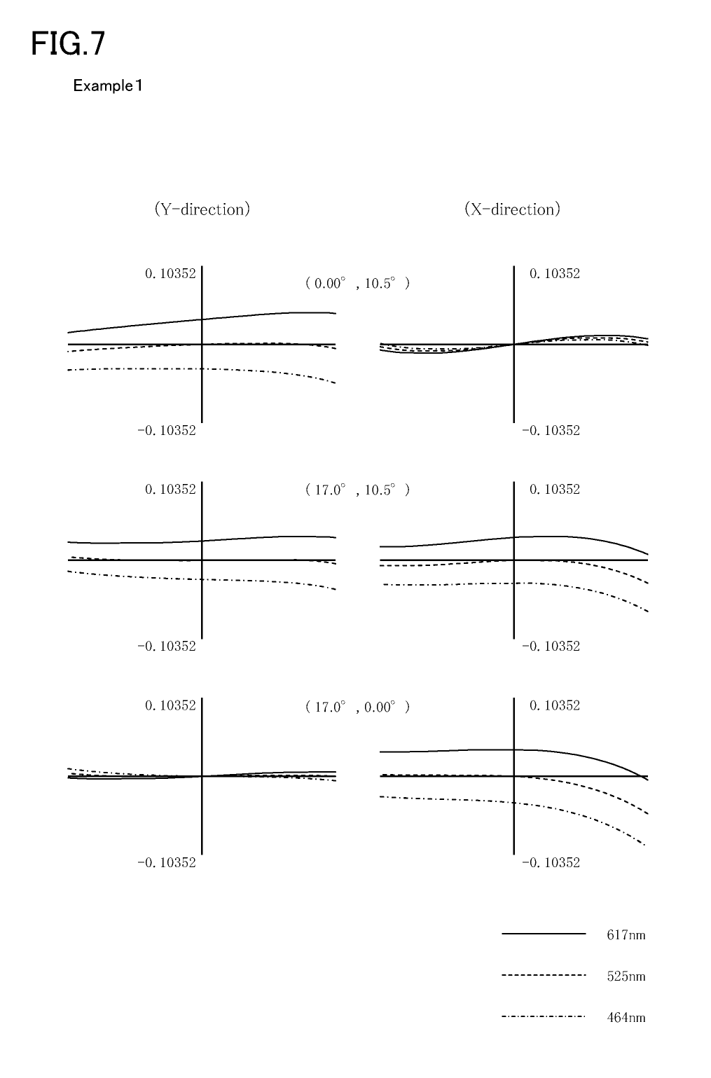

FIG. 4 is a sectional view of the decentered optical system of Example 1 including its center chief ray, and FIG. 5 is a plan view of the decentered optical system of Example 1. FIGS. 6 and 7 are aberrational diagrams for the decentered optical system of Example 1.

In order from an image plane Im₁ (an image display plane in the case of a projecting optical system or an imaging (image-taking) plane in the case of an imaging optical system) toward an object plane (a virtual or real image projecting plane in the case of a projecting optical system or an object plane in the case of an imaging optical system), the decentered optical system 1 of Example 1 includes a first optical element 10 and a second optical element 20, and an aperture stop S acting as an exit pupil is formed on the object-plane side of the second optical element 20. The surfaces of the first 10, and the second optical element 20 are each decentered with respect to a center chief ray Lc that is defined by a light ray traveling from the image plane Im₁ through the center of the exit pupil to the center of the object plane.

The first 11, the second 12 and the third surface 13 of the optical element 10 are each formed of or defined by a rotationally asymmetric free-form surface. The first surface 21 of the second optical element 20 is formed of or defined by a rotationally asymmetric free-form surface while the second surface 22 of the second optical element 20 is formed of or defined by a plane.

Reference is then made to ray tracing in the case of using the decentered optical system 1 with the image projector apparatus. Light rays exiting out from an image plane Im₁ acting as the display plane of an image display device 50 passes through the entrance surface 51a and exit surface 51b of a cover glass 51, entering the first optical element 10 from the first surface 11. The light rays incident from the first surface 11 are reflected at the second surface 12 and then at the third surface 13, exiting out from the first optical element 10 from the second surface 12. The light rays exiting out from the first optical element 10 enters the second optical element 20 from the first surface 21, exiting out from the second surface 22. The light rays exiting out from the second optical element 20 pass through an aperture stop S acting as an exit pupil for projection onto the pupil of a viewer, a screen or the like.

The decentered optical system 1 of Example 1 also includes a direct-vision optical path in which the third surface 13 of the first optical element 10 is used as a transmission surface.

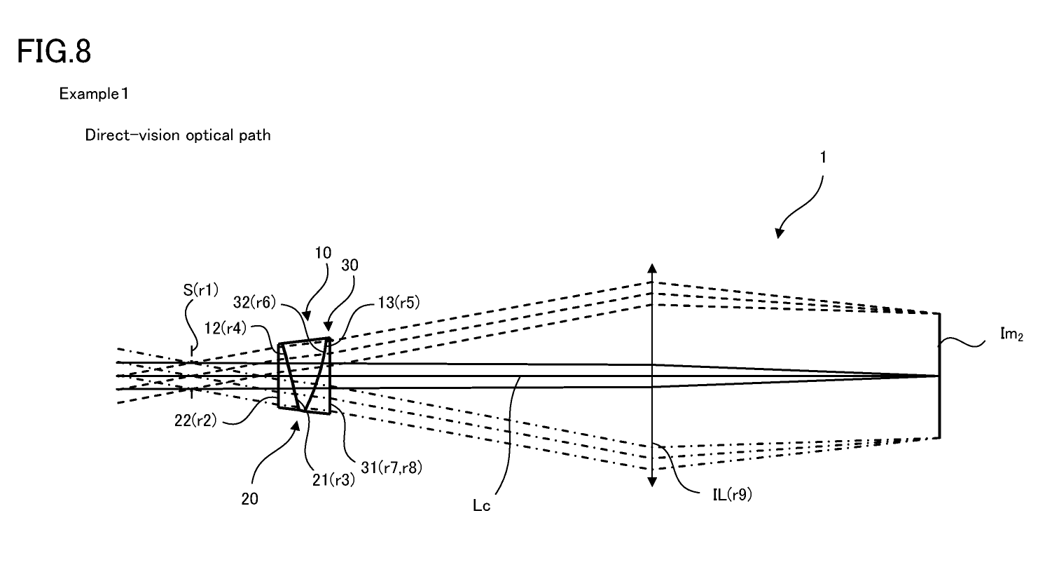

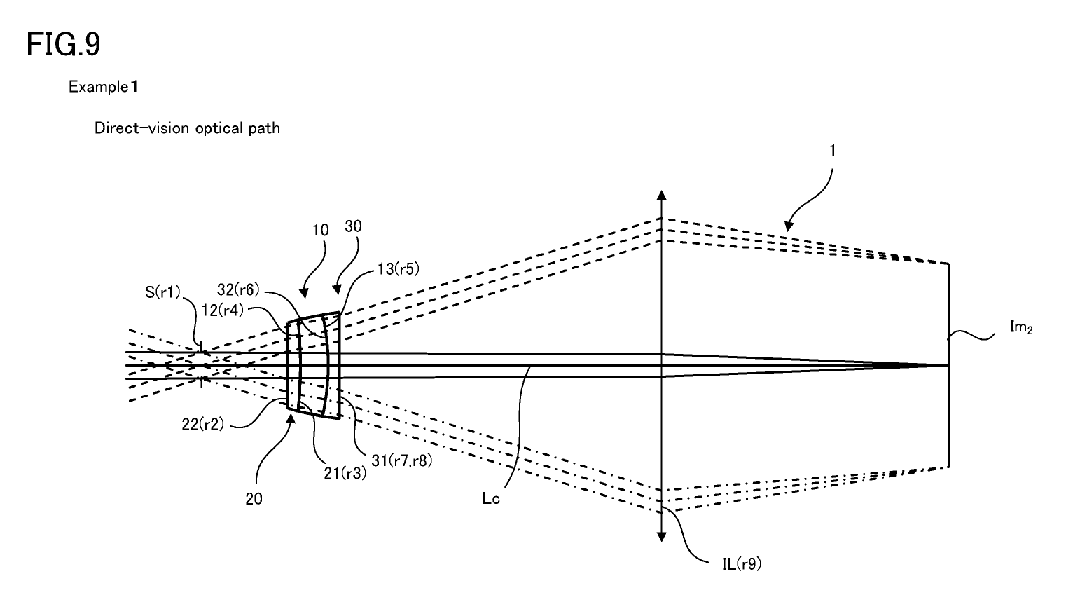

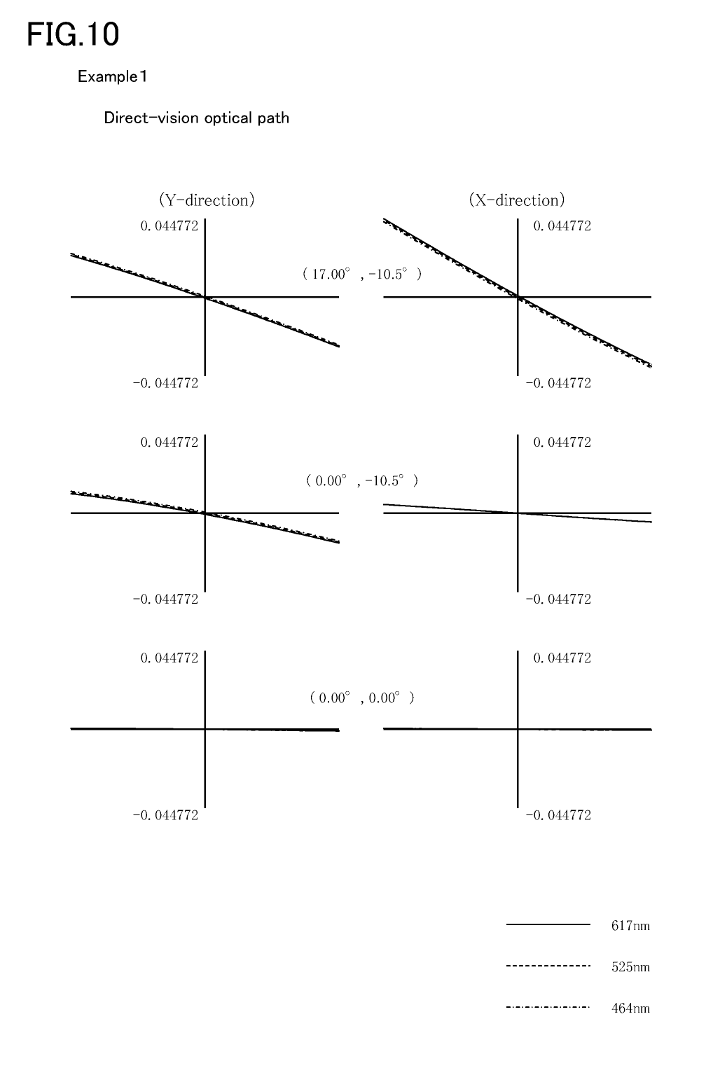

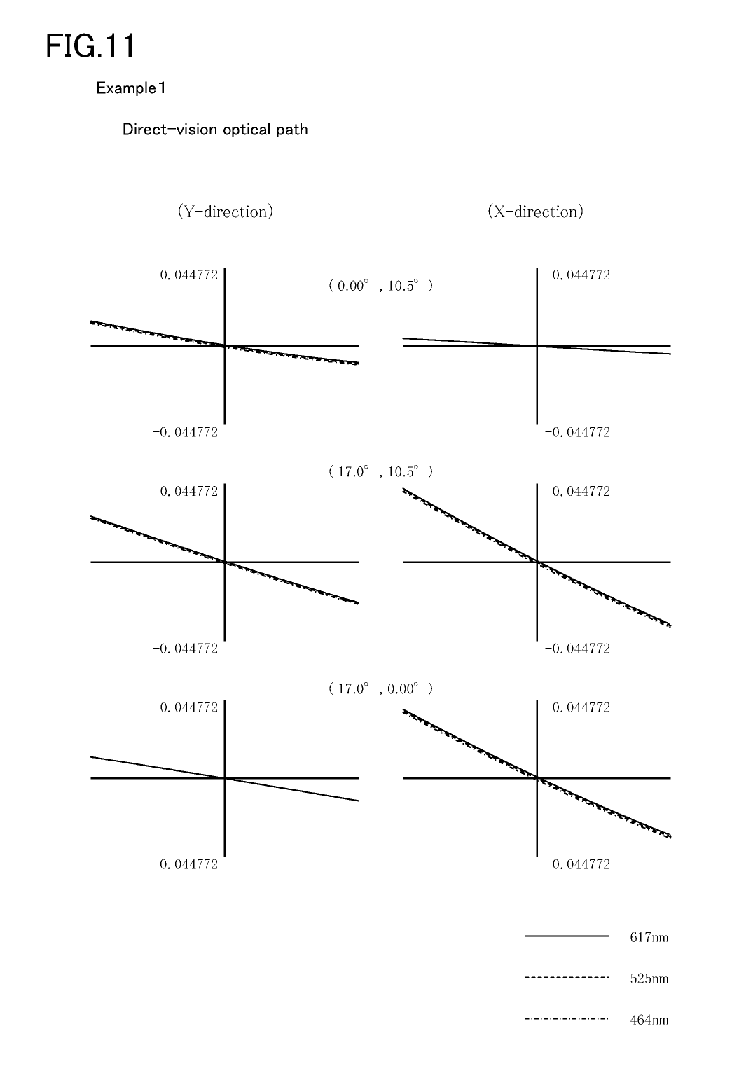

FIG. 8 is a sectional view of the decentered optical system of Example 1 including the center chief ray of its direct-vision optical path, and FIG. 9 is a plan view of the direct-vision optical path taken through the de-centered optical system of Example 1. FIGS. 10 and 11 are aberrational diagrams for the direct-vision optical path taken through the decentered optical system of Example 1.

When used as a direct-vision optical path, the de-centered optical system 1 includes, in order from an external virtual image plane Im₂ toward the virtual object plane of a viewer's eyeball side, a third optical element 30, a first optical element 10, and a second optical element 20, and an aperture stop S as an exit pupil is provided or formed on the object plane side of the second optical element 20. The surfaces of the third 30, the first 10 and the second optical element 20 are each de-centered with respect to a center chief ray Lc here defined as a light ray that travels from the image plane Im₂ through the center of the exit pupil to the center of the object plane.

The second surface 12, and third surface 13 of the first optical element 10 is formed of or defined by a rotationally asymmetric free-form surface. The first surface 21 of the second optical element 20 is defined by a rotationally asymmetric free-form surface, and the second surface 22 of the second optical element 20 is defined by a plane. The first surface 31 of the third optical element 30 is defined by a plane, and the second surface 32 of the third optical element 30 is defined by a rotationally asymmetric free-form surface.

Reference is now made to ray tracing for the direct-vision optical path through the decentered optical system 1. As shown in FIG. 1, light rays exiting out from the image plane Im₂ enter the third optical element 30 from the first surface 31, leaving the second surface 32. After leaving the second surface 32 of the third optical element 30, the light rays enter the first optical element 10 from the third surface 13. The light rays exit from the second surface 12 enter the second optical element 20 from the first surface 21, exiting out from the second surface 22. The light rays exiting out from the second optical element 20 pass through the aperture stop S acting as an exit pupil for projection onto the pupil of a viewer, a screen or the like.

It is here to be noted that the decentered optical system 1 of Example 1 may be used with an image projector apparatus having an image display device 50 located at the image plane Im₁ and an imaging apparatus having an imaging device located at Im₁ as well. Although an ideal or perfect lens IL is shown in FIGS. 8 and 9, it is understood that in the absence of the ideal lens IL there will be the image plane Im₂ actually located farer away. It is also understood that if the position of the aperture stop S of the example here is replaced by the imaging (image-taking) plane and the position of the image plane Im₁ is substituted by the aperture stop, there can then be an imaging optical system available.

The specifications for the decentered optical system 1 of Example 1 set up as a viewing optical system are:

Horizontal angle of view: 34.0°

Vertical angle of view: 21.0°

Pupil diameter: 8 mm

Image display device size: 15.7 mm×9.7 mm

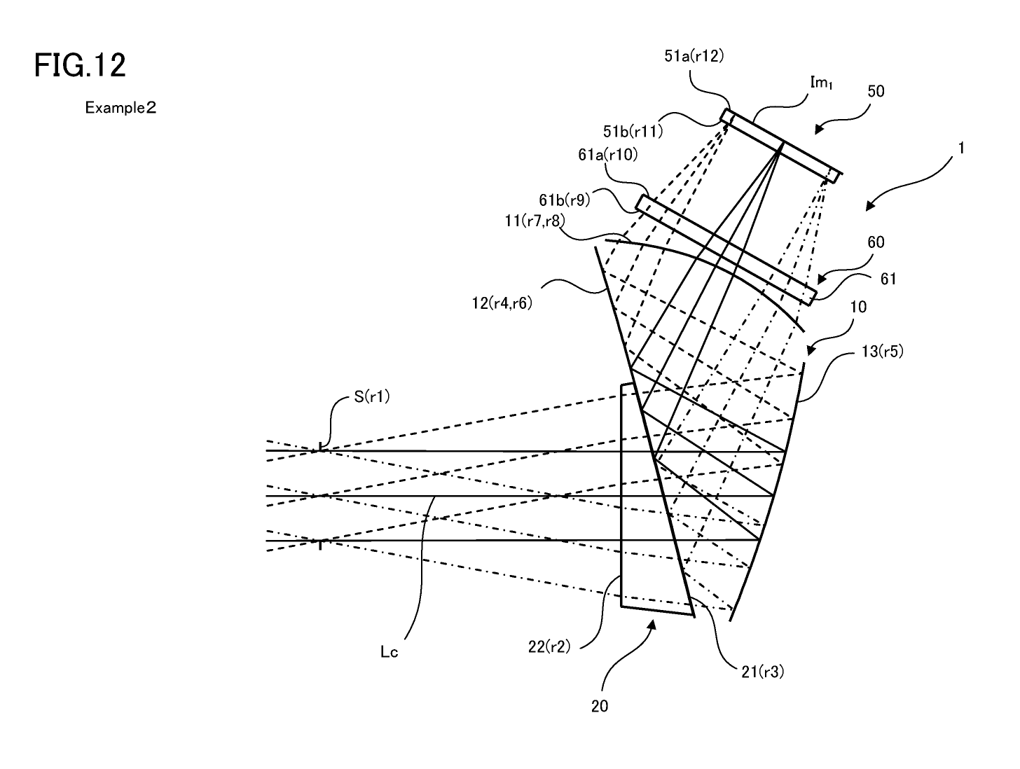

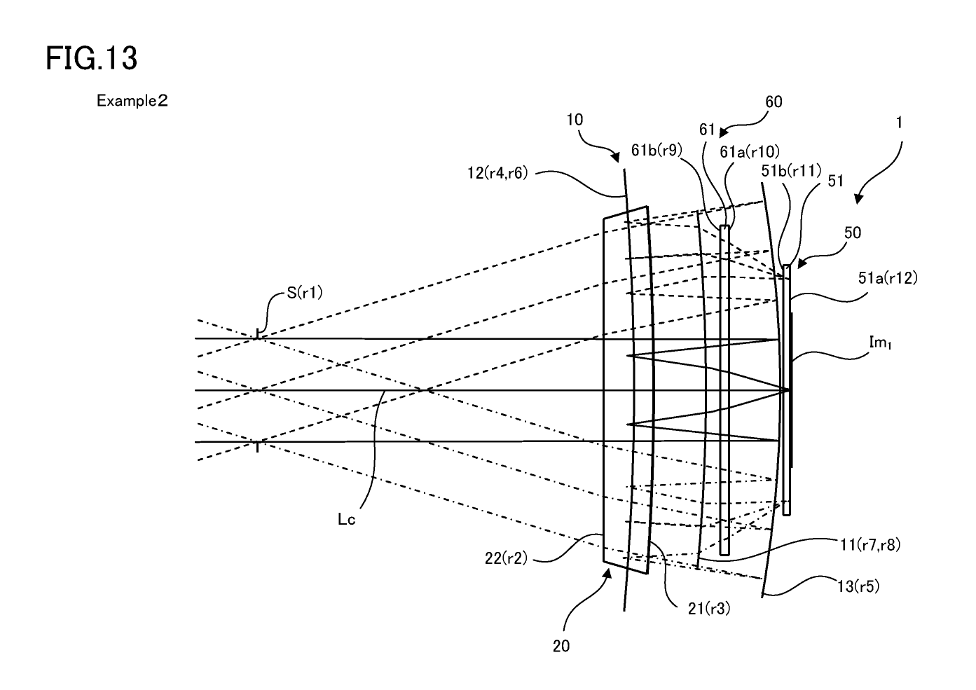

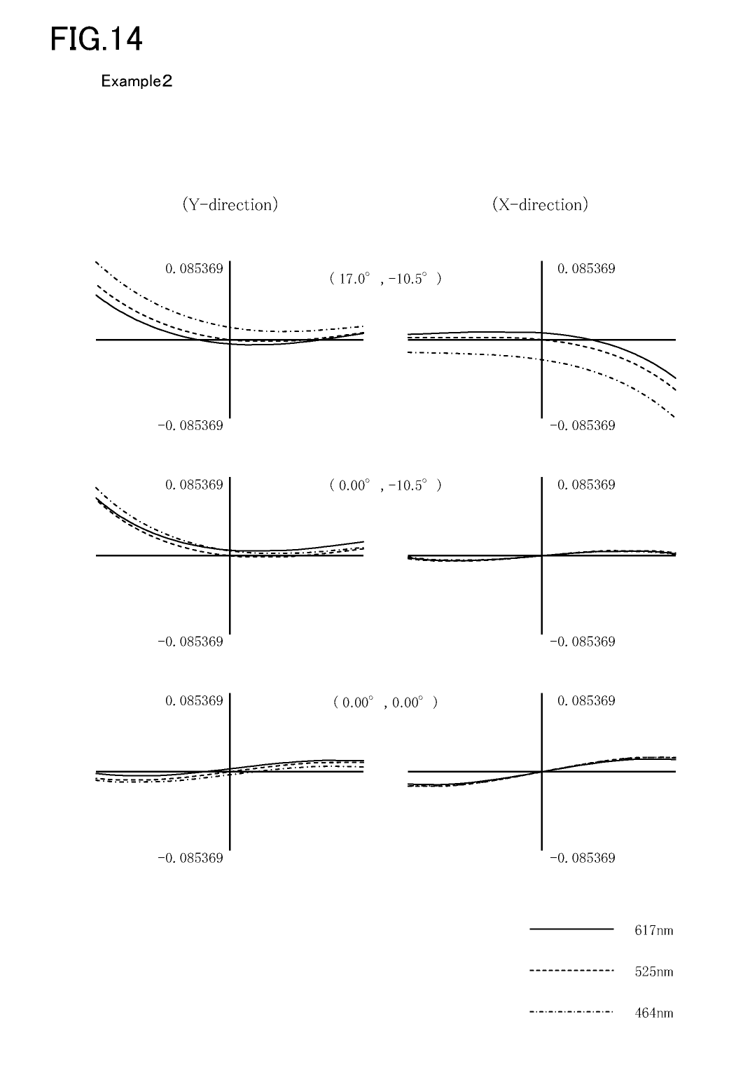

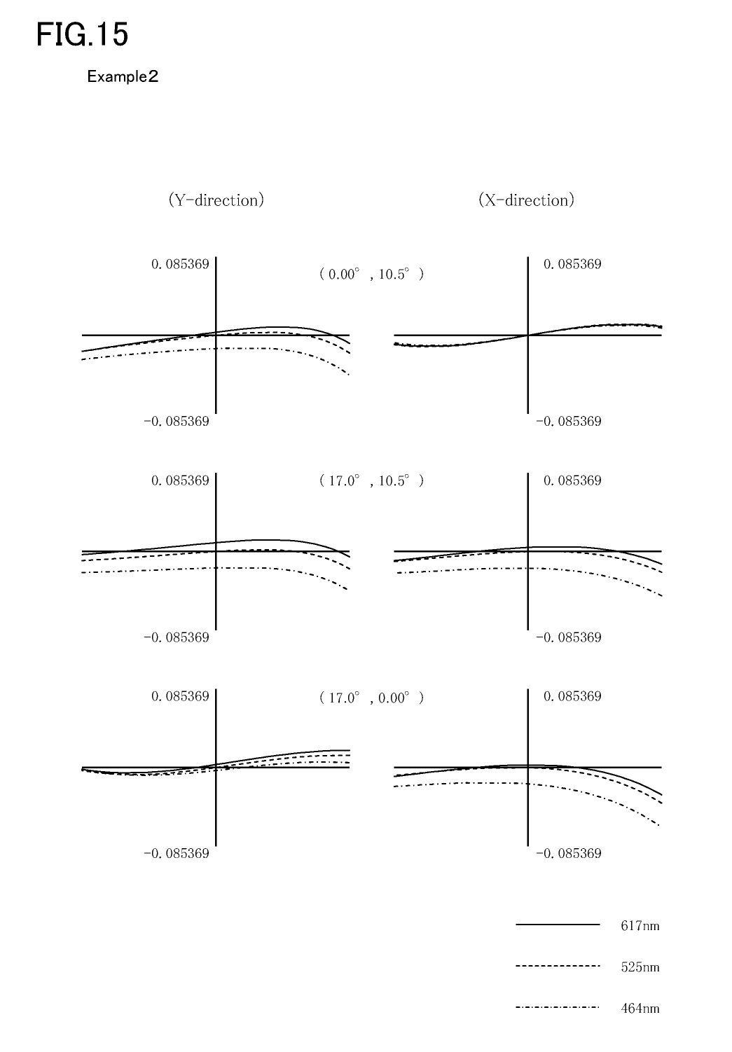

FIG. 12 is a sectional view of the decentered optical system of Example 2 including the center chief ray, and FIG. 13 is a plan view of the decentered optical system of Example 2. FIGS. 14 and 15 are aberrational diagrams for the decentered optical system of Example 2.

The decentered optical system 1 according to Example 2 includes, in order from the image plane Im₁ toward the object plane, a diffractive optical element 61 that forms or defines a diffractive optical surface 60, a first optical element 10 and a second optical element 20, and an aperture stop S acting as an exit pupil is provided or formed on the object plane side of the second optical element 20. The surfaces of the first 10 and second optical element 20 are each decentered with respect to its center chief ray Lc that is here defined as a light ray traveling from the image plane Im₁ through the center of the exit pupil to the center of the object plane.

The first 11, second 12, and third surface 13 of the first optical element 10 is formed of or defined by a rotationally asymmetric free-form surface. The first surface 21 of the second optical element 20 is defined by a rotationally asymmetric free-form surface, and the second surface 22 of the second optical element 20 is defined by a plane. The first surface 61a of the diffractive optical element 61 is formed of or defined by such a diffractive optical surface 60 as shown in FIGS. 2A-2F.

Reference is then made to ray tracing in the case of using the decentered optical system 1 with an image projector apparatus. Exiting out from the image plane Im₁ acting as the display plane of an image display device 50, light rays pass through the entrance surface 51a and exit surface 51b of a cover glass 51 and then through the first 61a and second surface 61b of the diffractive optical element 61, entering the first optical element 10 from the first surface 11. Entering from the first surface 11, the light rays are reflected at the second surface 12 and further at the third surface 13, leaving the first optical element 10 from the second surface 12. Exiting out from the first optical element 10, the light rays are incident on the second optical element 20 from the first surface 21, leaving the second surface 22. Leaving the second optical element 20, the light rays pass through an aperture stop S acting as an exit pupil for projection onto the pupil of a viewer, a screen or the like.

The decentered optical system 1 of Example 2 also includes a direct-vision optical path in which the third surface 13 of the first optical element 10 is used as a transmission surface.

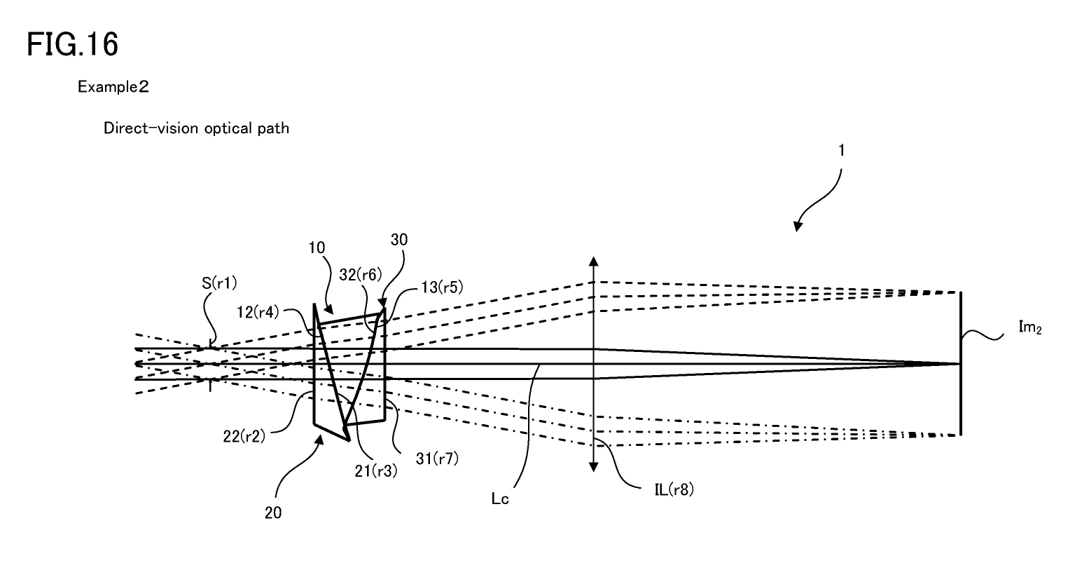

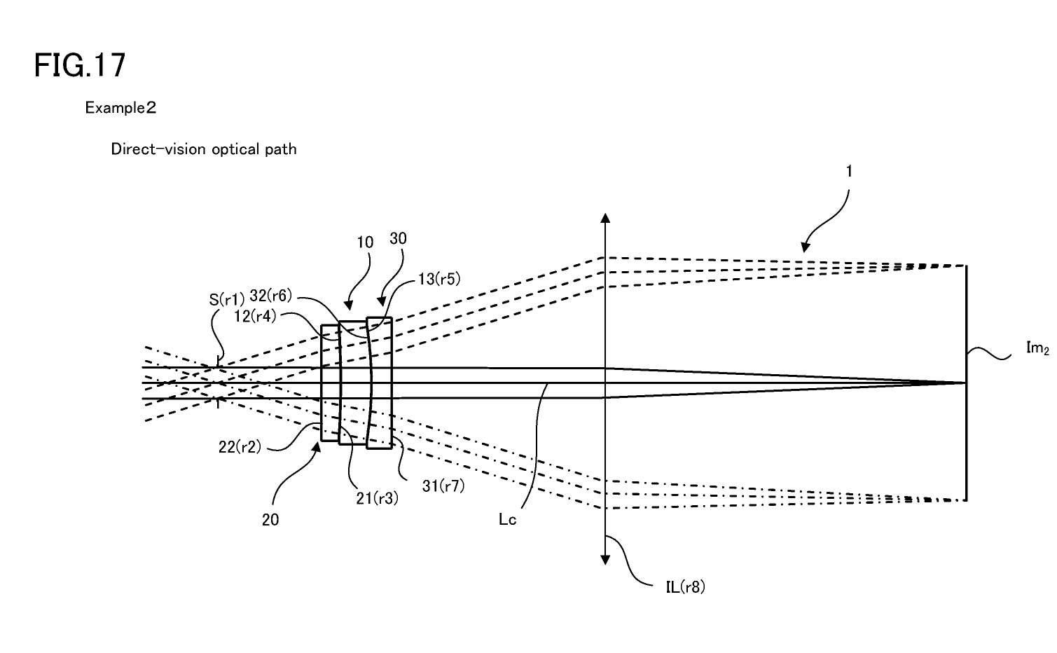

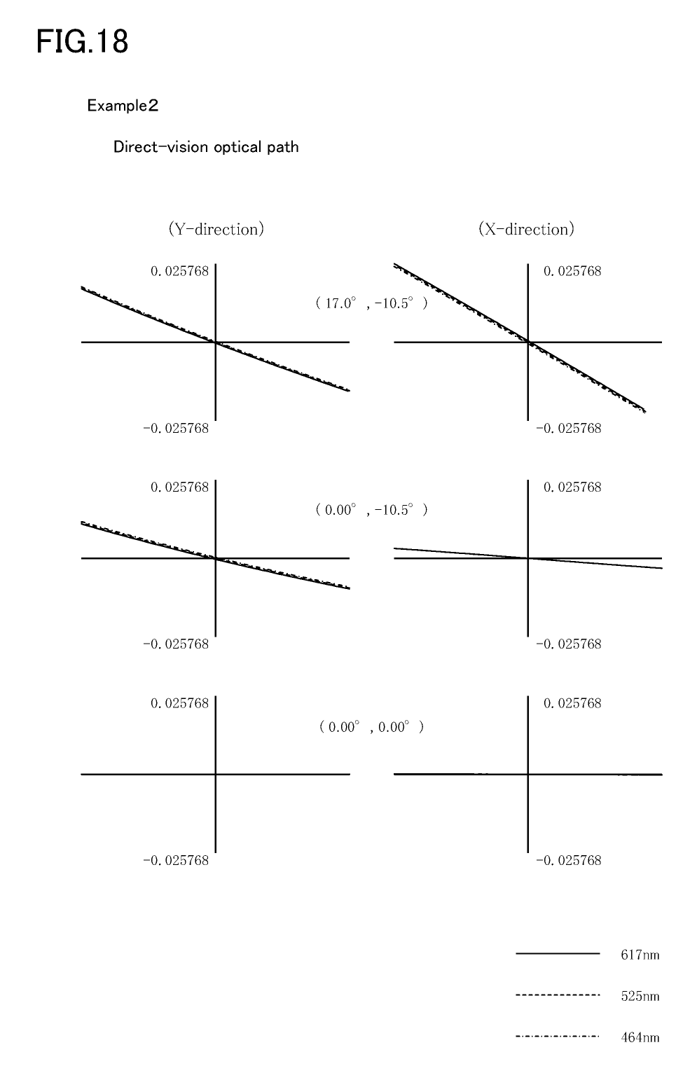

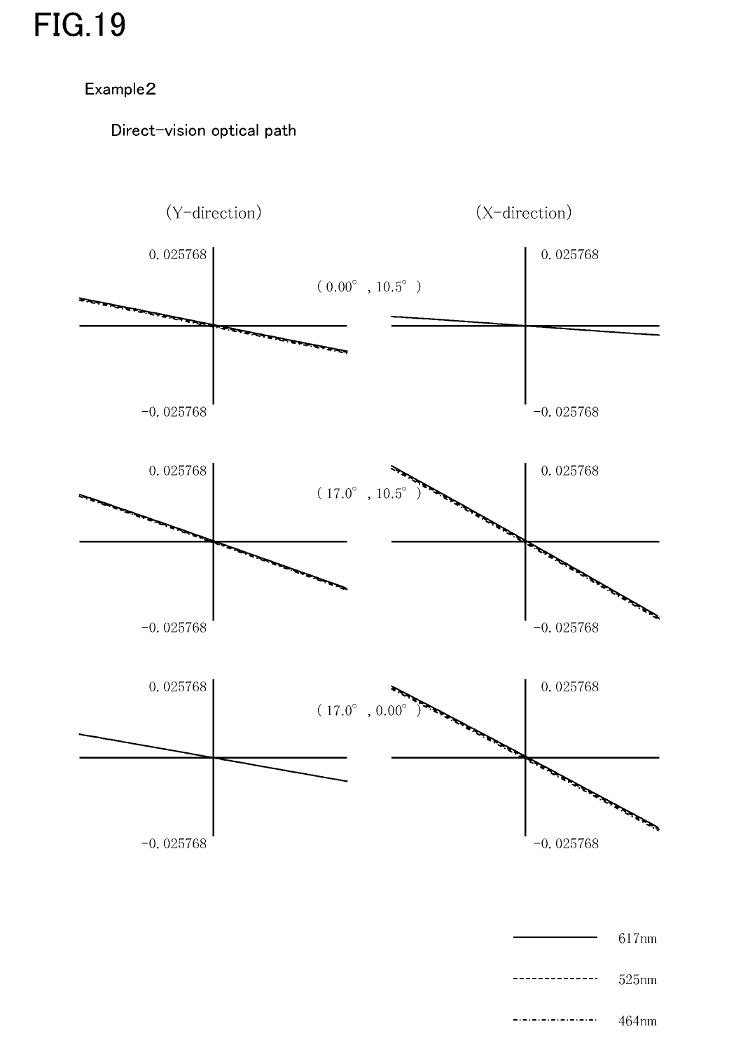

FIG. 16 is a sectional view of the decentered optical system of Example 2 including the center chief ray of its direct-vision optical path, and FIG. 17 is a plan view of the direct-vision optical path taken through the decentered optical system of Example 2. FIGS. 18 and 19 are aberrational diagrams for the direct-vision optical path taken through the decentered optical system of Example 2.

When used as a direct-vision optical path, the de-centered optical system 1 includes, in order from the image plane Im₂ toward the object plane, a third optical element 30, a first optical element 10 and a second optical element 20, and an aperture stop S as an exit pupil is provided or formed on the object plane side of the second optical element 20. The surfaces of the third 30, first 10 and second optical element 20 are each decentered with respect to its center light ray Lc here defined as a light ray traveling from the image plane Im₂ through the center of the exit pupil to the center of the object plane.

The second 12, and third surface 13 of the first optical element 10 is formed of or defined as a rotationally asymmetric free-form surface. The first surface 21 of the second optical element 20 is defined by a rotationally asymmetric free-form surface, and the second surface 22 of the second optical element 20 is defined by a plane. The first surface 31 of the third optical element 30 is defined by a plane while the second surface 32 of the third optical element 30 is defined by a rotationally asymmetric free-form surface.

Reference is then made to ray tracing for the direct-vision optical path taken through the decentered optical system 1. Exiting out from the image plane Im₂, the light rays enters the third optical element 30 from the first surface 31, and exits out from the second surface 32. Exiting out from the second surface 32 of the third optical element 30, the light rays are incident on the first optical element 10 from the third surface 13. Incident from the third surface 13, the light rays leave the first optical element 10 from the second surface 12. Exiting out from the first optical element 10, the light rays enter the second optical element 20 from the first surface 21, and leave the second surface 22. Exiting out from the second optical element 20, the light rays pass through an aperture stop S acting as an exit pupil for projection onto the pupil of a viewer, a screen or the like.

It is here to be noted that the decentered optical system 1 of Example 2 may be used with an image projector apparatus having an image display device 50 located at the image plane Im₁ and an imaging apparatus having an imaging device located at Im₁ as well. Although an ideal or perfect lens IL is shown in FIGS. 16 and 17, it is understood that in the absence of the ideal lens IL there will be the image plane Im₂ actually located farer away.

The specifications for the decentered optical system 1 of Example 2 set up as a viewing optical system are:

Horizontal angle of view: 34.0°

Vertical angle of view: 21.0°

Pupil diameter: 12 mm

Image display device size: 15.7 mm×9.7 mm

Aspect ratio: 4:3

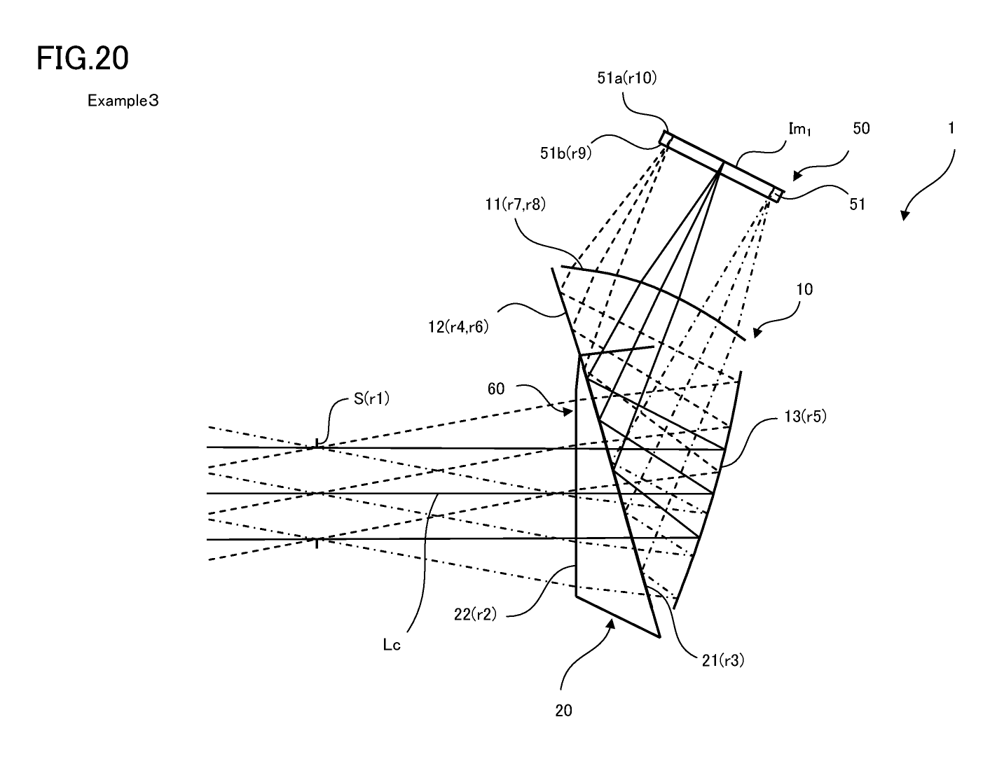

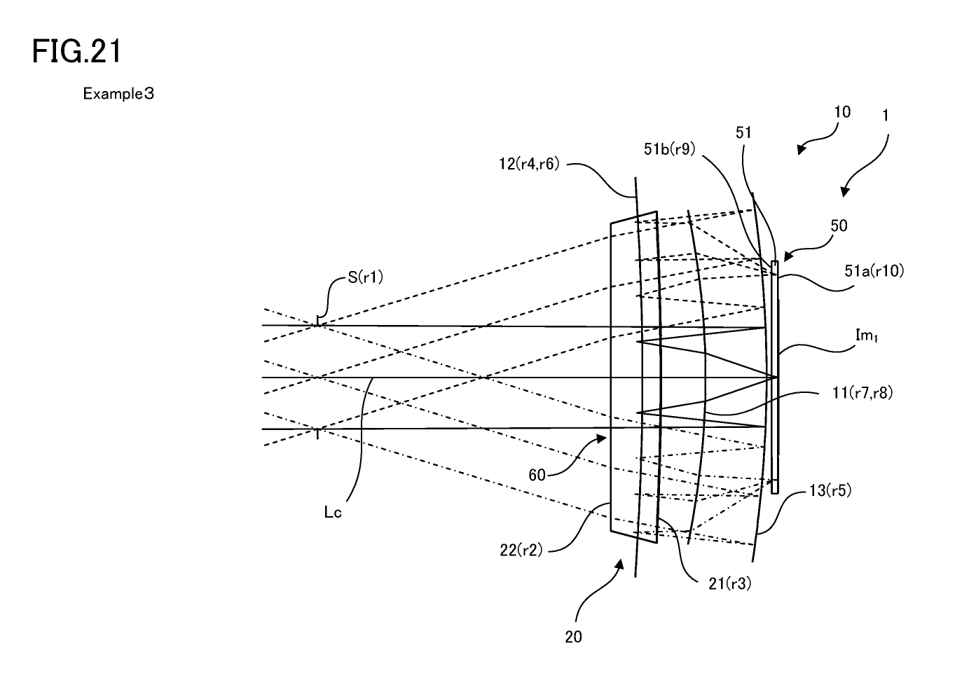

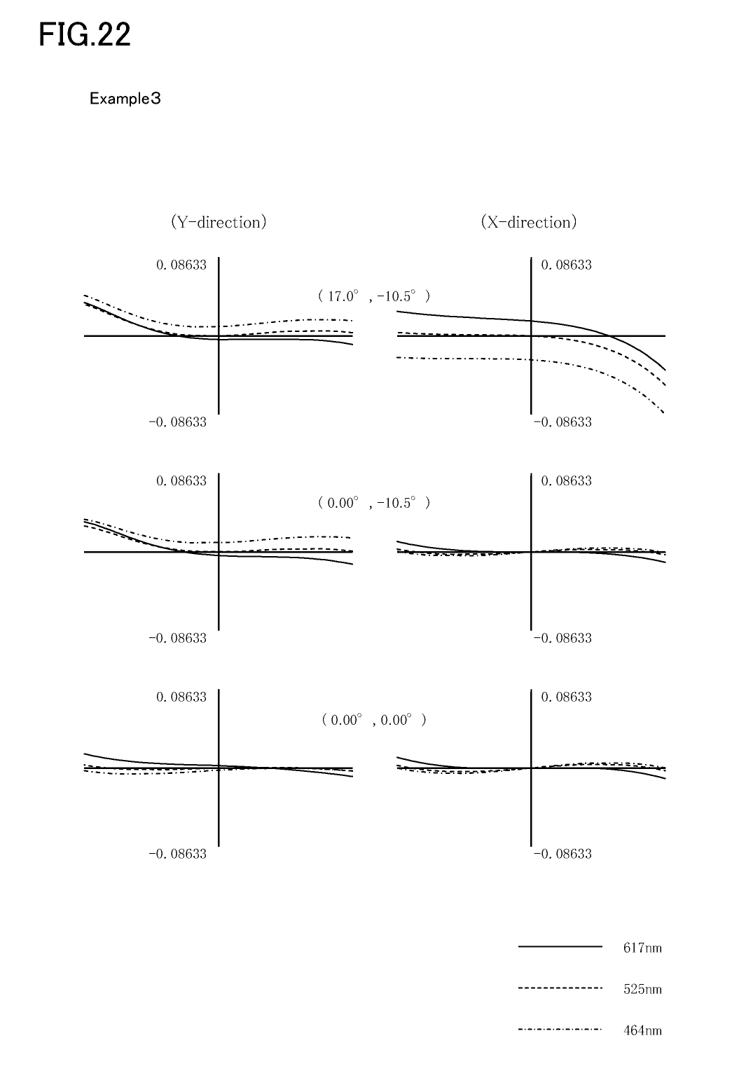

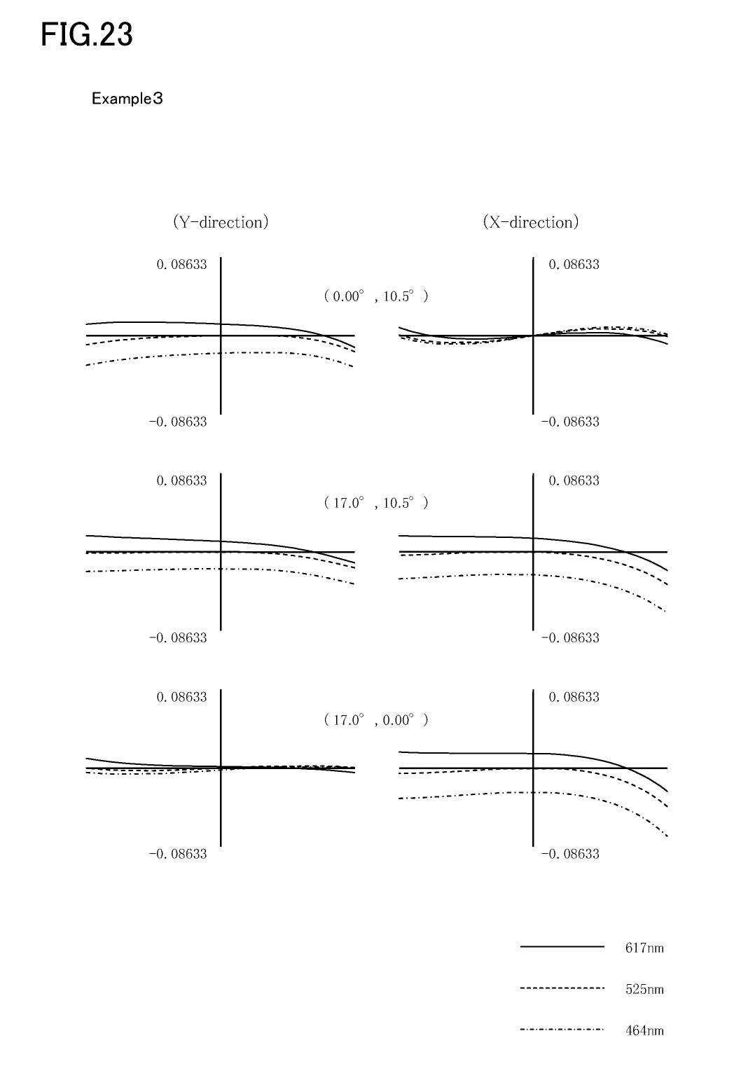

FIG. 20 is a sectional view of the decentered optical system of Example 3 including the center chief ray, and FIG. 21 is a plan view of the decentered optical system of Example 3. FIGS. 22 and 23 are aberrational diagrams for the decentered optical system of Example 3.

In order from the image plane Im₁ toward the object plane, the decentered optical system 1 of Example 3 includes a first optical element 10 and a second optical element 20, and an aperture stop S acting as an exit pupil is provided or formed on the object plane side of the second optical element 20. The surfaces of the first 10 and second optical element 20 are each decentered with respect to its center chief ray Lc here defined by a light ray traveling from the image plane Lm₁ through the center of the exit pupil to the center of the object plane.

The first 11, second 12, and third surface 13 of the first optical element 10 is formed of or defined by a rotationally asymmetric free-form surface. The first surface 21 of the second optical element 20 is defined by a rotationally asymmetric free-form surface while the second surface 22 of the second optical element 20 is defined by a diffractive optical surface 60.

Reference is then made to ray tracing in the case of using the decentered optical system 1 with an image projector apparatus. Exiting out from the image plane Im₁ as the image display plane of an image display device 50, the light rays pass through the entrance surface 51a and exit surface 51b of a cover glass 51, and then enter the first optical element 10 from the first surface 11. Incident from the first surface 11, the light rays are reflected at the second surface 12 and further at the third surface 13, leaving the first optical element 10 from the second surface 12. After leaving the first optical element 10, the light rays are incident on the second optical element 20 from the first surface 21, and exit out from the second surface 22. Leaving the second optical element 20, the light rays pass through the aperture stop S acting as the exit pupil for projection onto the pupil of a viewer, a screen or the like.

The decentered optical system 1 of Example 3 also includes a direct-vision optical path using the third surface 13 of the first optical element 10 as a transmission surface.

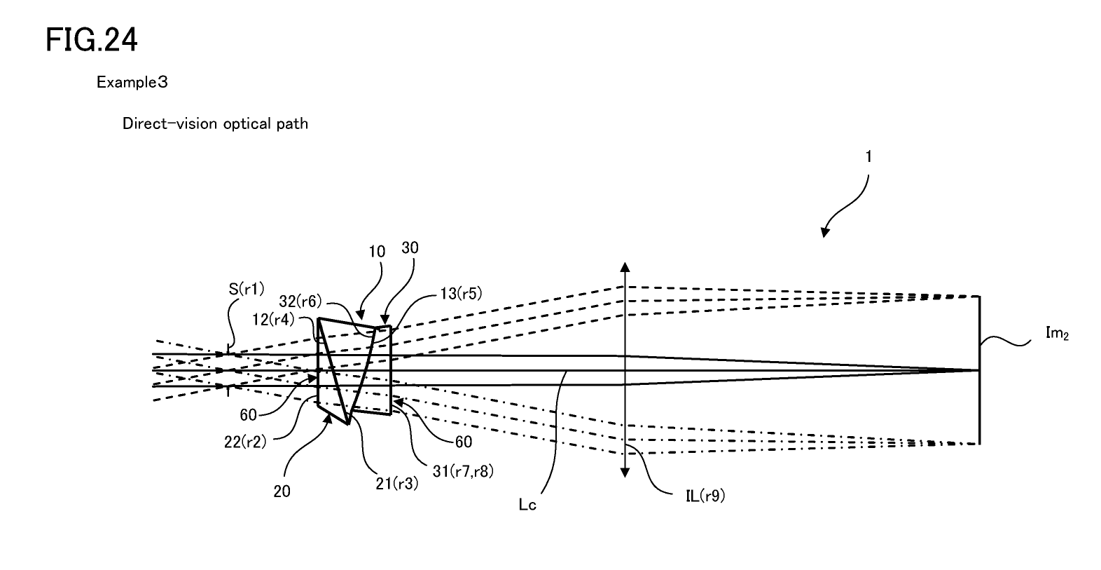

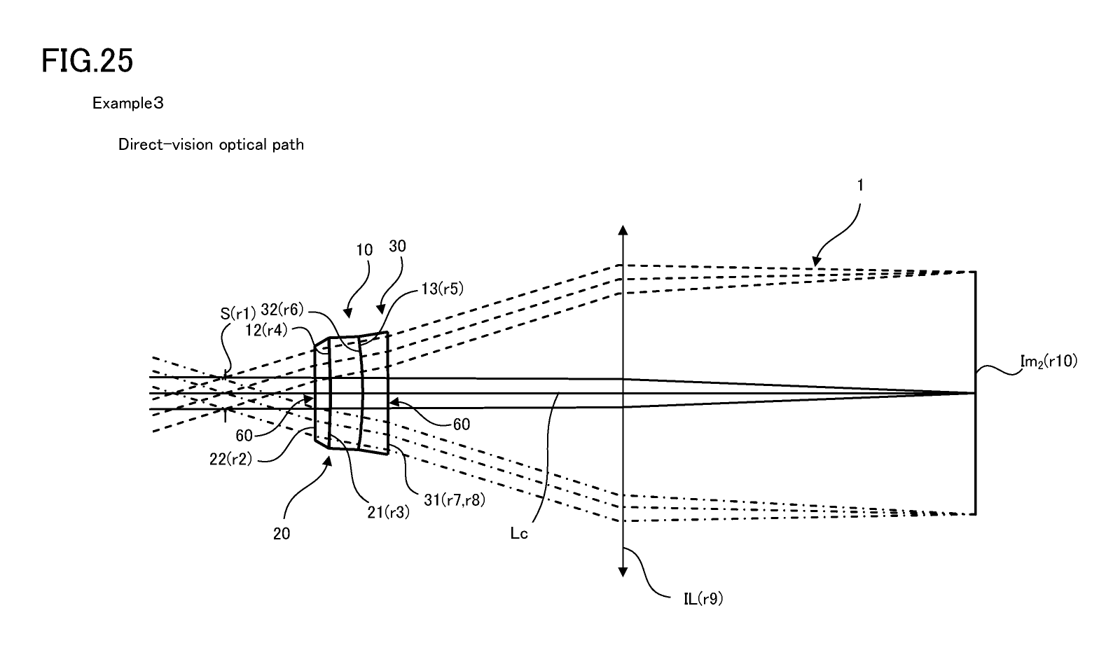

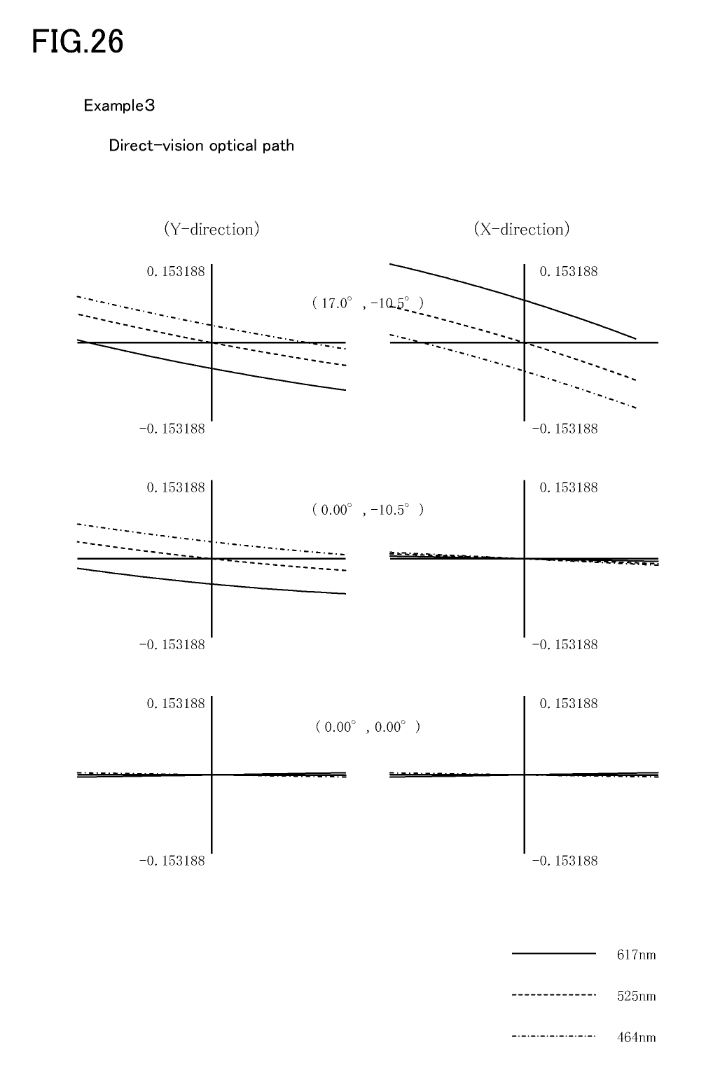

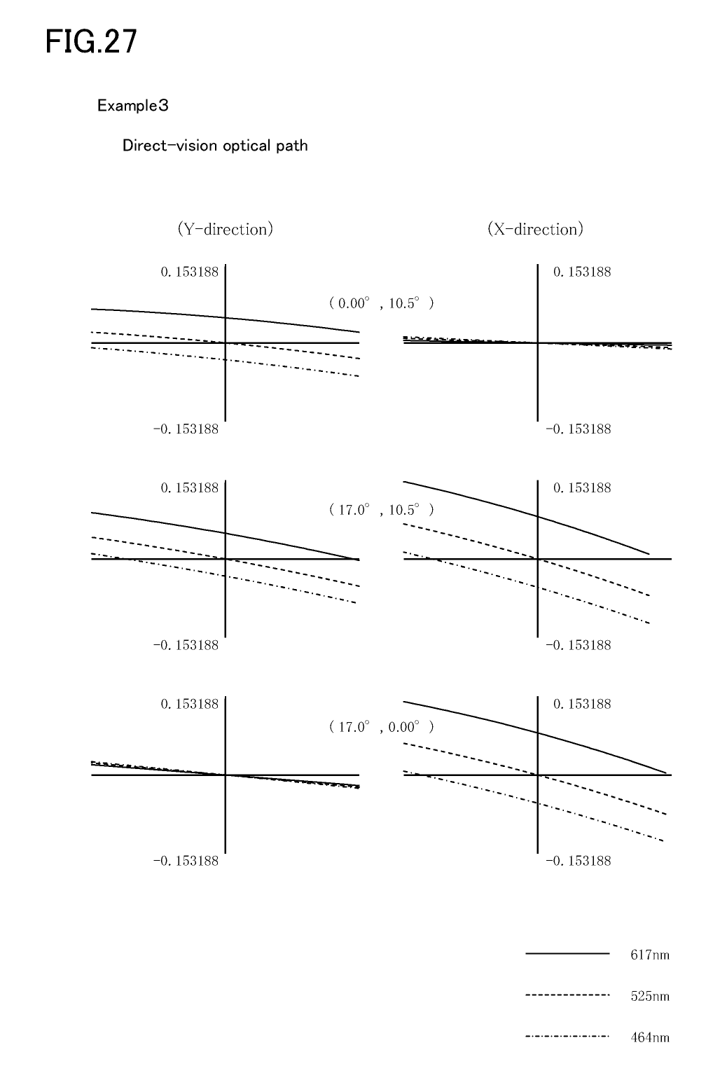

FIG. 24 is a sectional view of the decentered optical system of Example 3 including the center chief ray of its direct-vision optical path, and FIG. 25 is a plan view of the direct-vision optical path taken through the decentered optical system of Example 3. FIGS. 26 and 27 are aberrational diagrams for the direct-vision optical path taken through the decentered optical system of Example 3.

When used as a direct-vision optical path, the de-centered optical system 1 includes, in order from the image plane Im₂ toward the object plane, a third optical element 30, a first optical element 10 and a second optical element 20, and an aperture stop S acting as an exit pupil is provided or formed on the object plane side of the second optical element 20. The surfaces of the third 30, first 10 and second optical element 20 are each decentered with respect to its center light ray Lc here defined by a light ray traveling from the image plane Im₂ through the center of the exit pupil toward the center of the object plane.

The second 12 and third surface 13 of the first optical element 10 is formed of or defined by a rotationally asymmetric free-form surface. The first surface 21 of the second optical element 20 is defined by a rotationally asymmetric free-form surface, and the second surface 22 of the second optical element 20 is defined by a diffractive optical surface 60. The first surface 31 of the third optical element 30 is defined by a diffractive optical surface 60 while the second surface 32 of the third optical element 30 is defined by a rotationally asymmetric free-form surface.

Reference is then made to ray tracing for the direct-vision optical path taken through the decentered optical system 1. Exiting out from the image plane Im₂, the light rays enter the third optical element 30 from the first surface 31, and leave it from the second surface 32. The light rays leaving the third optical element 30 from the second surface 32 are incident on the first optical element 10 from the third surface 13. Exiting out from the first optical element 10, the light rays are incident on the second optical element 20 from the first surface 21, and exits out from the second surface 22. Leaving the second optical element 20, the light rays pass through an aperture stop S acting as an exit pupil for projection onto the pupil of a viewer, a screen or the like.

It is here to be noted that the decentered optical system 1 of Example 3 may be used with an image projector apparatus having an image display device 50 located at the image plane Im₁ and an imaging apparatus having an imaging device located at Im₁ as well. Although an ideal or perfect lens IL is shown in FIGS. 24 and 25, it is understood that in the absence of the ideal lens IL there may be the image plane Im₂ actually located farer away.

The specifications for the decentered optical system 1 of Example 3 set up as a viewing optical system are:

Horizontal angle of view: 34.0°

Vertical angle of view: 21.0°

Pupil diameter: 8 mm

Image display device size: 15.7 mm×9.7 mm

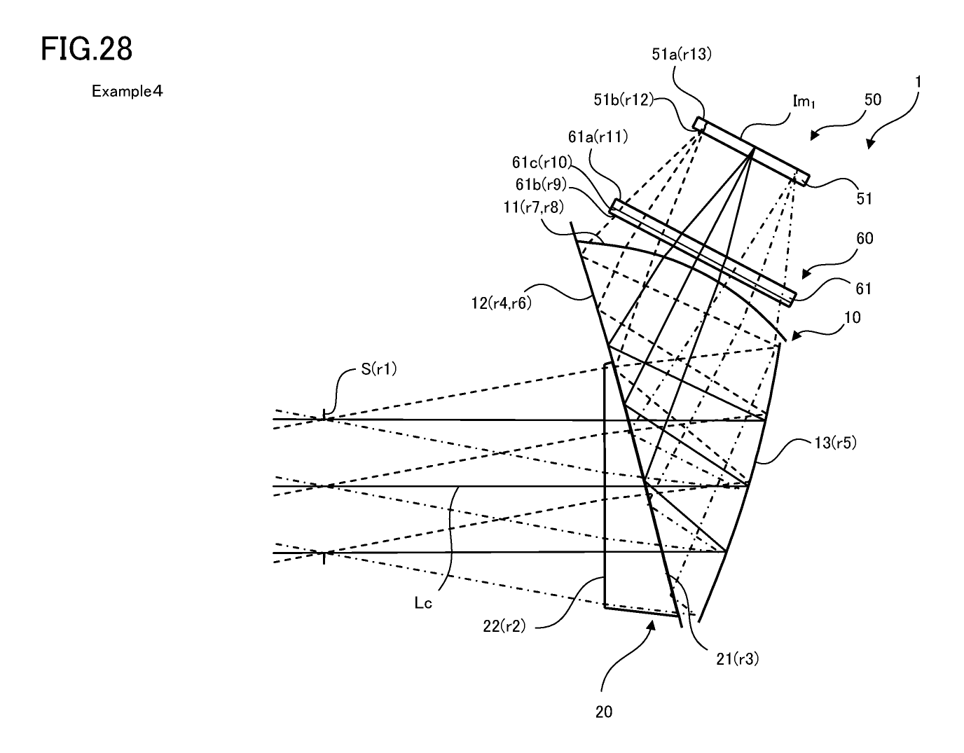

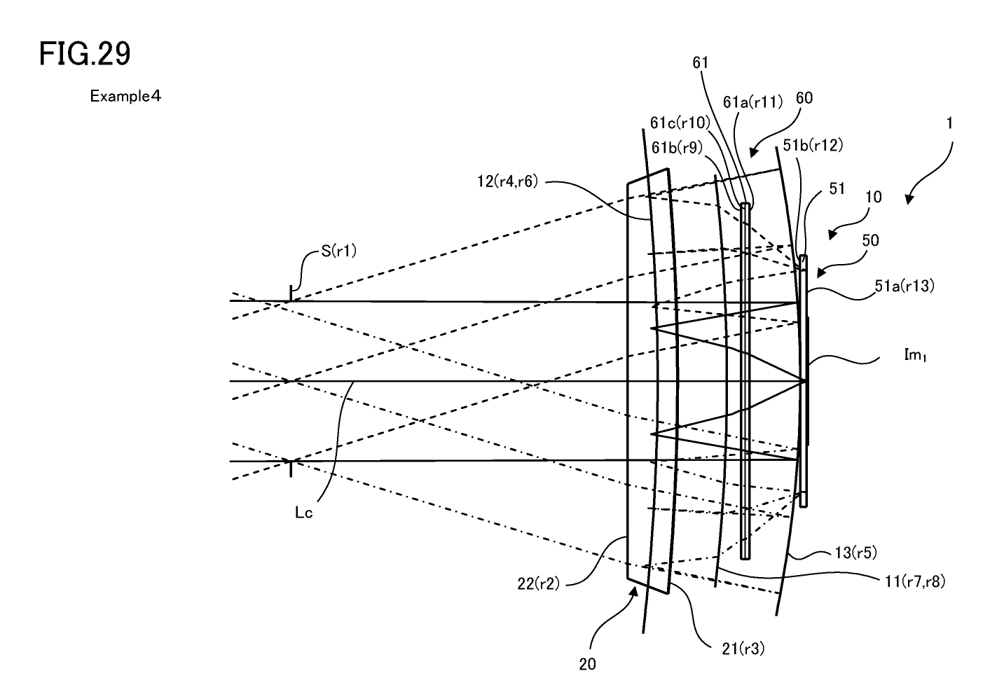

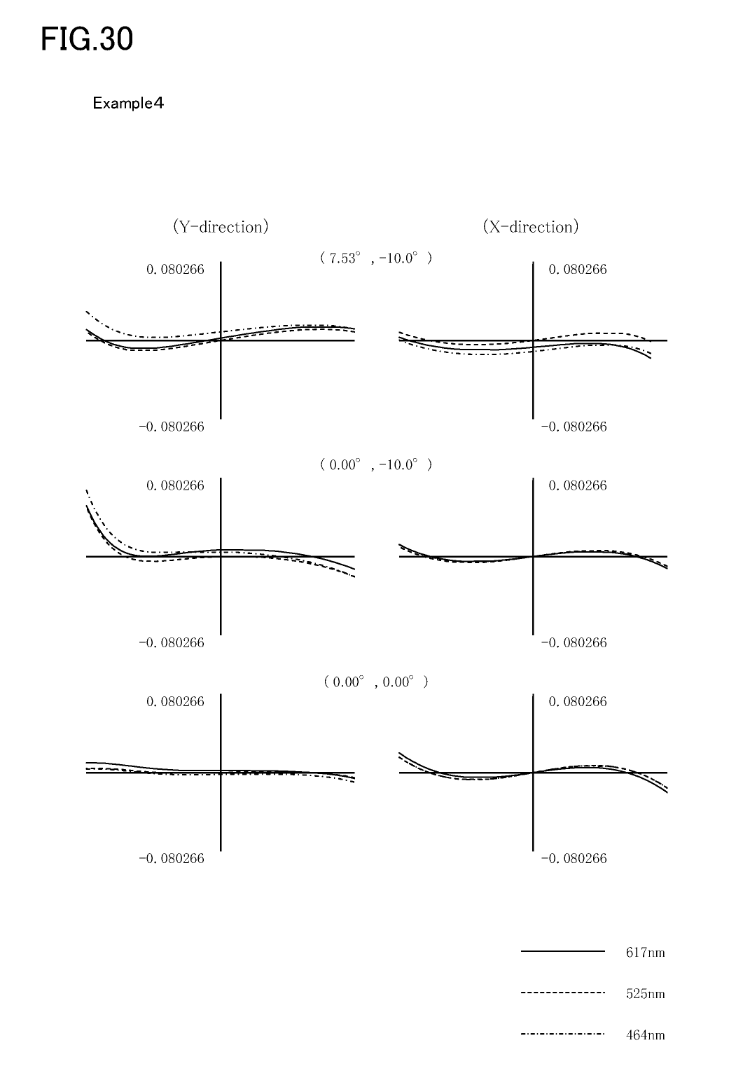

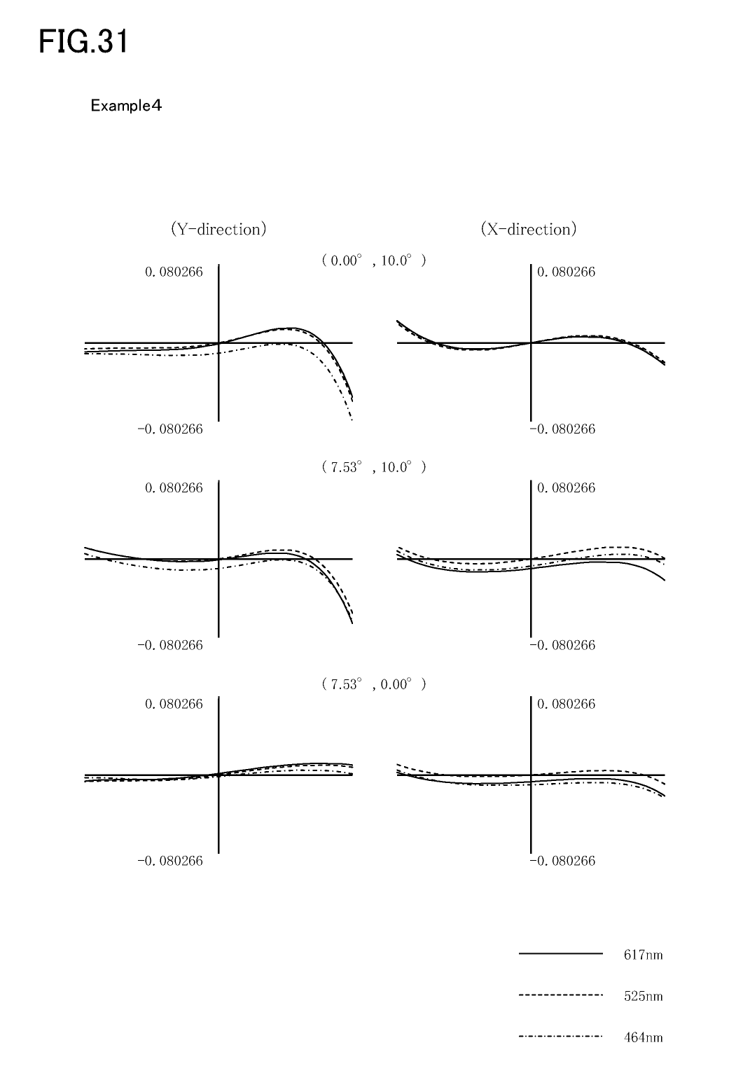

FIG. 28 is a sectional view of the decentered optical system of Example 4 including its center chief ray, and FIG. 29 is a plan view of the decentered optical system of Example 4. FIGS. 30 and 31 are aberrational diagrams for the decentered optical system of Example 4.

In order from the image plane Im₁ toward the object plane, the decentered optical system 1 of Example 4 includes a diffractive optical element 61, a first optical element 10 and a second optical element 20, and an aperture stop S acting as an exit pupil is provided or formed on the object plane side of the second optical element 20. The surfaces of the first 10 and second optical element 20 are each decentered with respect to a center chief ray Lc here defined by a light ray traveling from the image plane Im₁ through the center of the exit pupil to the center of the object plane.

The first 11, second 12, and third surface 13 of the first optical element 10 is formed of or defined by a rotationally asymmetric free-form surface. The first surface 21 of the second optical element 20 is defined by a rotationally asymmetric free-form surface while the second surface 22 of the second optical element 20 is defined by a plane. A diffractive optical element 61 forms or defines such a diffractive optical surface 60 as shown in FIG. 3.

Reference is then made to ray tracing in the case of using the decentered optical system 1 with an image projector apparatus. Exiting out from the image plane Im₁ acting as the display plane of an image display device 50, light rays pass through the entrance surface 51a and exit surface 51b of a cover glass 51 and through the first surface 61a, cemented surface 61c and second surface 61b of the diffractive optical element 61, and enter the first optical element 10 from the first surface 11. The light rays incident from the first surface 11 are reflected at the second surface 12 and further at the third surface 13, leaving the first optical element 10 from the second surface 12. The light rays leaving the first optical element 10 are incident on the second optical element 20 from the first surface 21, leaving it from the second surface 22. The light rays exiting out from the second optical element 20 pass through the aperture stop S acting as the exit pupil for projection onto the pupil of a viewer, a screen or the like.

The decentered optical system 1 of Example 4 also includes a direct-vision optical path in which the third surface 13 of the first optical element 10 is used as a transmission surface.

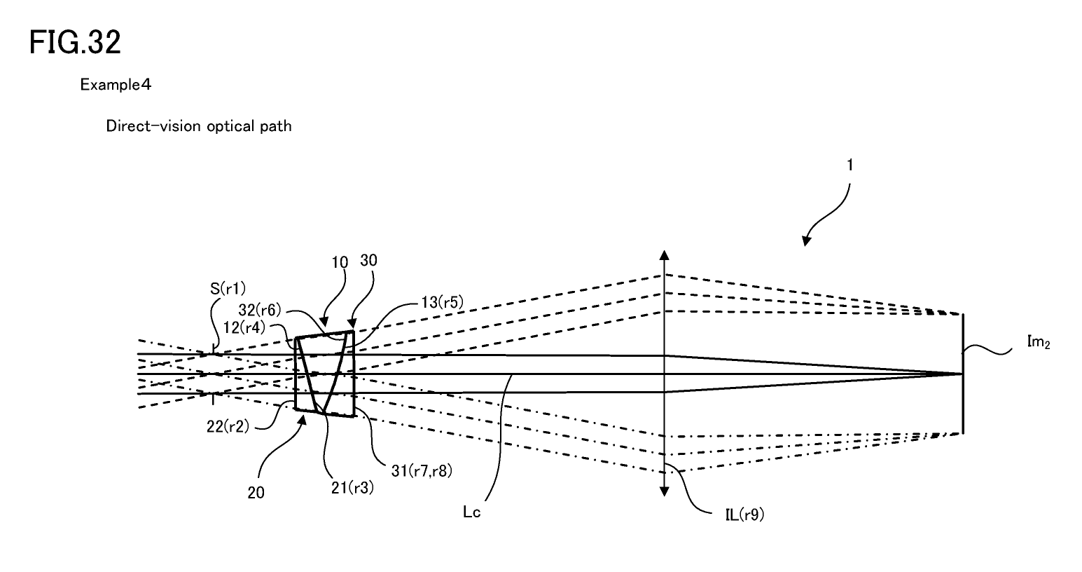

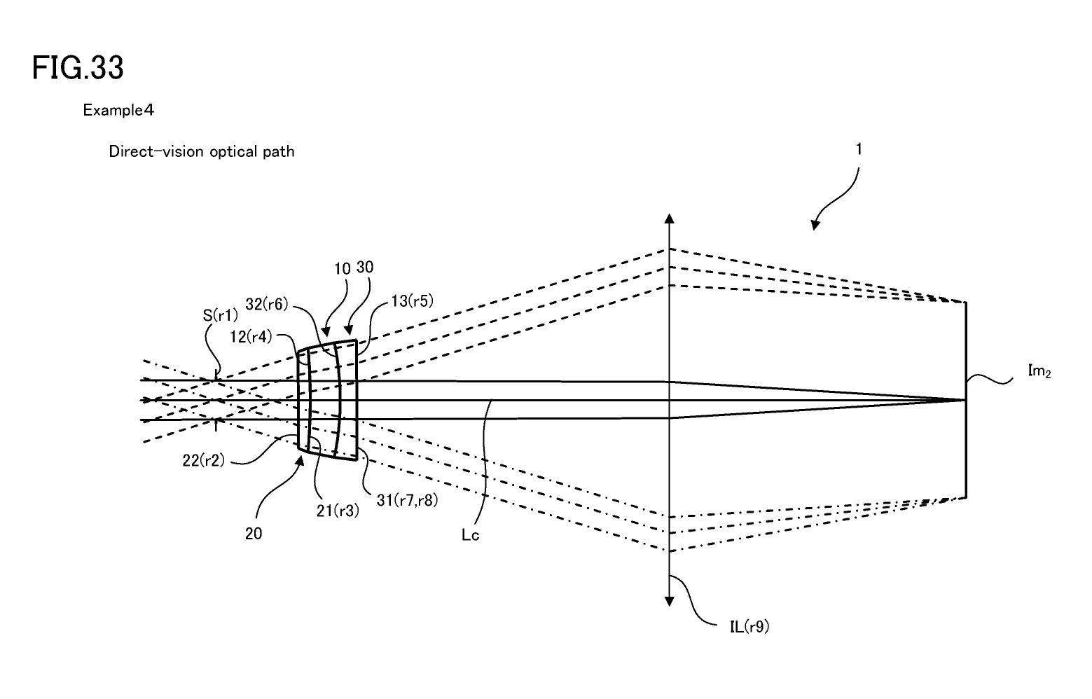

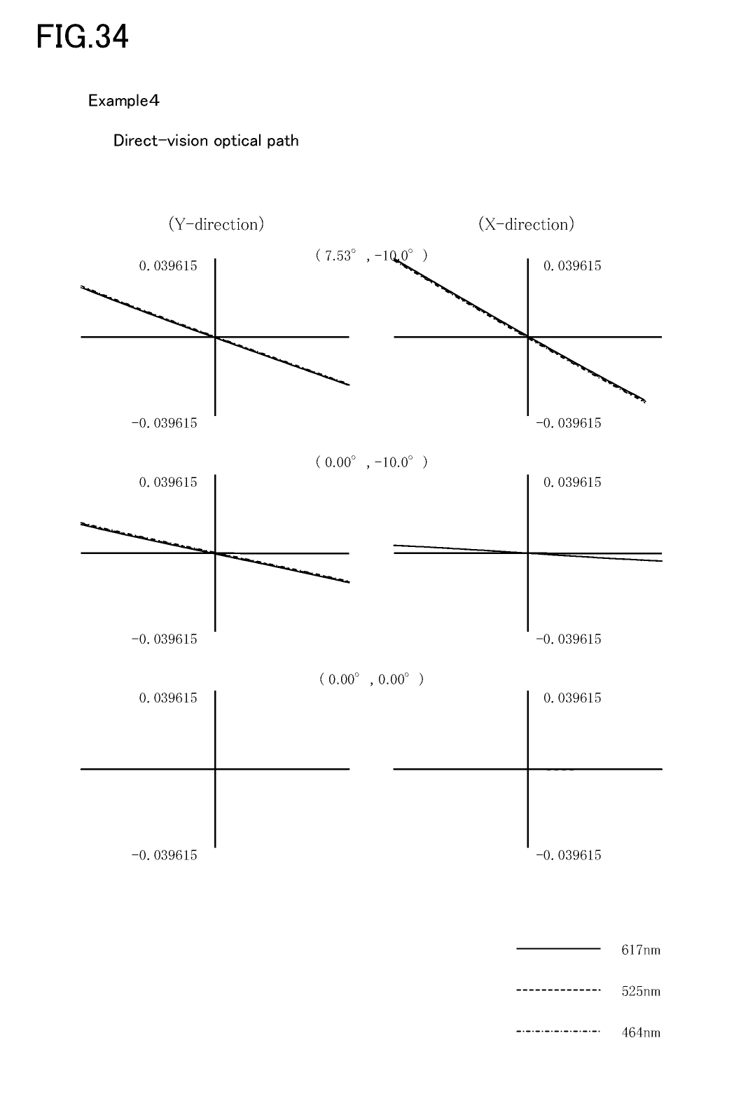

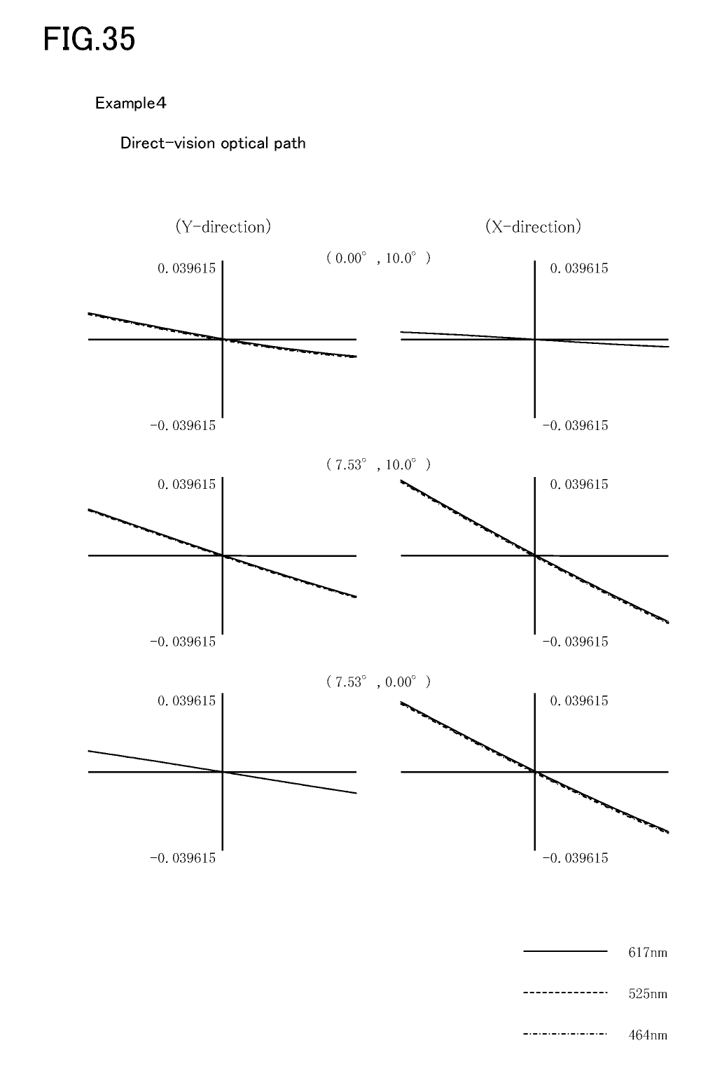

FIG. 32 is a sectional view of the decentered optical system of Example 4 including the center chief ray of its direct-vision optical path, and FIG. 33 is a plan view of the direct-vision optical path taken through the decentered optical system of Example 4. FIGS. 34 and 35 are aberrational diagrams for the direct-vision optical path taken through the decentered optical system of Example 4.

When used as a direct-vision optical path, the de-centered optical system 1 includes, in order from the image plane Im₂ toward the object plane, a third optical element 30, a first optical element 10 and a second optical element 20, and an aperture stop S acting as an exit pupil is provided or formed on the object plane side of the second optical element 20. The surfaces of the third 30, first 10, and the second optical element 20 are each de-centered with respect to a center chief ray Lc here defined by a center chief ray traveling from the image plane Im₂ through the center of the exit pupil to the center of the object plane.

The second 12, and third surface 13 of the first optical element 10 is formed of or defined by a rotationally asymmetric free-form surface. The first surface 21 of the second optical element 20 is defined by a rotationally asymmetric free-form surface while the second surface 22 of the second optical element 20 is defined by a plane. The first surface 31 of the third optical element 30 is defined by a plane while the second surface 32 of the third optical element 30 is defined by a rotationally asymmetric free-form surface.

Reference is the made to ray tracing for the direct-vision optical path through the decentered optical system 1. Light rays exiting out from the image plane Im₂ are incident on the third optical element 30 from the first surface 31, leaving it from the second surface 32. The light rays emitting out from the second surface 32 of the third optical element 30 are incident on the first optical element 10 from the third surface 13. The light rays incident from the third surface 13 exit out from the second surface 12 of the first optical element 10. The light rays exiting out from the first optical element 10 are incident on the second optical element 20 from the first surface 21, exiting out from the second surface 22. The light rays leaving the second optical element 20 pass through the aperture stop S as the exit pupil for projection onto the pupil of a viewer, a screen or the like.

It is here to be noted that the decentered optical system 1 of Example 4 may be used with an image projector apparatus having an image display device 50 located at the image plane Im₁ and an imaging apparatus having an imaging device located at Im₁ as well. Although an ideal or perfect lens IL is shown in FIGS. 32 and 33, it is understood that in the absence of the ideal lens IL there may be the image plane Im₂ actually located farer away.

The specifications for the decentered optical system 1 of Example 4 set up as a viewing optical system are:

Horizontal angle of view: 34.0°

Vertical angle of view: 21.0°

Pupil diameter: 12 mm

Image display device size: 15.7 mm×9.7 mm

Set out below are configuration parameters for Examples 1 to 4.

First of all, the coordinate system used here is explained.

As shown in FIG. 1, let the Z axis be an optical axis defined by a straight line of the center chief ray Lc intersecting the second surface 22 of the second optical element 20 in the decentered optical system, the Y axis be defined by an axis that is orthogonal to that Z axis and lies within a decentered plane of each of the surfaces forming the optical system, and the X axis be an axis that is orthogonal to the optical axis and to the Y axis, i.e., an axis that goes downward from the front plane of the drawing sheet. The direction of ray tracing may be described by ray tracing that takes place from the object plane (not shown) on the exit pupil side toward the image plane Im.

The rotationally asymmetric surface used in the embodiments described here is preferably a free-form surface.

The configuration of the free-form surface FFS used in the embodiments described here is defined by the following formula (a). Suppose here that the Z-axis of that defining formula is the axis of the free-form surface FFS, and the coefficient terms with no data given are zero.

$$Z = {cr}^{2} / [ 1 + \sqrt{ } \{ 1 - ( 1 + k ) {c}^{2} {r}^{2} \} ] + {\sum }_{j = 2}^{66} {C}_{j} {X}^{m} {Y}^{n} \qquad ( a )$$

Here the first term of Formula (a) is the spherical term, and the second term is the free-form surface term. In the spherical term,
c is the radius of curvature at the vertex,
k is the conic constant, and
r is √(X²+Y²).

The free-form surface term is:

$${\sum }_{j = 2}^{66} {C}_{j} {X}^{m} {Y}^{n} = {C}_{2} X + {C}_{3} Y + {C}_{4} {X}^{2} + {C}_{5} XY + {C}_{6} {Y}^{2} + {C}_{7} {X}^{3} + {C}_{8} {X}^{2} Y + {C}_{9} {XY}^{2} + {C}_{10} {Y}^{3} + {C}_{11} {X}^{4} + {C}_{12} {X}^{3} Y + {C}_{13} {X}^{2} {Y}^{2} + {C}_{14} {XY}^{3} + {C}_{15} {Y}^{4} + {C}_{16} {X}^{5} + {C}_{17} {X}^{4} Y + {C}_{18} {X}^{3} {Y}^{2} + {C}_{19} {X}^{2} {Y}^{3} + {C}_{20} {XY}^{4} + {C}_{21} {Y}^{5} + {C}_{22} {X}^{6} + {C}_{23} {X}^{5} Y {+}_{C 24} {X}^{4} {Y}^{2} + {C}_{25} {X}^{3} {Y}^{3} + {C}_{26} {X}^{2} {Y}^{4} + {C}_{27} {XY}^{5} + {C}_{28} {Y}^{6} + {C}_{29} {X}^{7} + {C}_{30} {X}^{6} Y + {C}_{31} {X}^{5} {Y}^{2} + {C}_{32} {X}^{4} {Y}^{3} + {C}_{33} {X}^{3} {Y}^{4} + {C}_{34} {X}^{2} {Y}^{5} + {C}_{35} {XY}^{6} + {C}_{36} {Y}^{7}$$

where Cⱼ (j is an integer of 2 or greater) is a coefficient.

In general, that free-form surface has no plane of symmetry in both the X-Z plane and the Y-Z plane. However, by bringing all the odd-numbered terms with respect to X down to zero, the free-form surface can have only one plane of symmetry parallel with the Y-Z plane. For instance, this may be achieved by bringing down to zero the coefficients for the terms C₂, C₅, C₇, C₉, C₁₂, C₁₄, C₁₆, C₁₈, C₂₀, C₂₃, C₂₅, C₂₇, C₂₉, C₃₁, C₃₃, C₃₅, in the above defining formula (a).

By bringing all the odd-numbered terms with respect to Y down to zero, the free-form surface can have only one plane of symmetry parallel with the X-Z plane. For instance, this may be achieved by bringing down to zero the coefficients for the terms C₃, C₅, C₈, C₁₀, C₁₂, C₁₄, C₁₇, C₁₉, C₂₁, C₂₃, C₂₅, C₂₇, C₃₀, C₃₂, C₃₄, C₃₆, . . . in the above defining formula.

If any one of the directions of the aforesaid plane of symmetry is used as the plane of symmetry and decentration is implemented in a direction corresponding to that, for instance, the direction of decentration of the optical system with respect to the plane of symmetry parallel with the Y-Z plane is set in the Y-axis direction and the direction of decentration of the optical system with respect to the plane of symmetry parallel with the X-Z plane is set in the X-axis direction, it is then possible to improve productivity while, at the same time, making effective correction of rotationally asymmetric aberrations occurring from decentration.

The aforesaid defining formula (a) is given for the sake of illustration alone as mentioned above: the feature of the embodiment is that by use of the rotationally asymmetric surface or free-form surface, it is possible to correct rotationally asymmetric aberrations occurring from decentration while, at the same time, improving productivity. It goes without saying that the same advantages are achievable even with any other defining formulae.

It is also to be understood that the diffractive optical surface is defined by a phase difference function method. In design, a diffractive optical surface may be expressed by adding an optical path difference function to it (see “An Introduction to Diffractive Optics” published by Optronics Co., Ltd. on May 2, 1997, pp. 18-29), the quantity of an added optical path length may be represented by the following equation (b) using a height h from the optical axis and an n-th degree (even-number degree) optical path difference function coefficient Pn.

φ(h)=P2h²+P4h⁴+P6h⁶+ . . . (b)

where P2, P4, P6, . . . are the second, the fourth, the sixth-order coefficients.

The optical path difference function φ(h) is indicative of an optical path difference between a virtual light ray that is not diffracted by a diffractive optical element structure at a point having a height h from the optical axis on a diffractive plane and a light ray that is diffracted by the diffractive optical element structure.

In the respective examples, the surfaces are each decentered within the Y-Z plane. Given to each decentered surface are the amount of decentration of the vertex of the surface from the origin of the coordinate system (X, Y and Z in the X-, Y- and Z-axis directions) and the angles (α, β, γ(°)) of tilt of the center axis of the surface (the Z axis defined in the formula (a) in case of a free-form surface) about the X-, Y- and Z-axes of the coordinate system. In that case, the positive α and β mean counterclockwise rotation with respect to the positive directions of the respective axes, and the positive γ means clockwise rotation with respect to the positive direction of the Z-axis.

When a specific surface (inclusive of a virtual surface) of the optical function surfaces forming the optical system of each example and the subsequent surface form together a coaxial optical system, there is a surface separation given. Decentration of the each decentered surface is defined on the same coordinate system.

The refractive indices and Abbe numbers on a d-line basis (587.56 nm wavelength) are given, and length is given in mm. The decentration of each surface is represented by the quantity of decentration from the reference surface, as mentioned above. The symbol “∞” affixed to the radius of curvature means that it is infinity.

It is also noted that the symbol “e” means that the numerical value subsequent to it is a power exponent having 10 as a base; for instance, “1.0e-5” means “1.0×10⁻⁵”.

### Example 1 (Viewing of Electronic Images)

| | | Surface | | Refractive | Abbe |
|---|---|---|---|---|---|
| Surface No. | Radius of curvature | separation | Decentration | index | number |
| Object plane | ∞ | −1000.00 | | | |
| 1 | Stop plane | 0.00 | | | |
| 2 | ∞ | 0.00 | Decentration(1) | 1.5254 | 56.2 |
| 3 | FFS[1] | 0.05 | Decentration(2) | | |
| 4 | FFS[1] | 0.00 | Decentration(2) | 1.5254 | 56.2 |
| 5 | FFS[2] | 0.00 | Decentration(3) | 1.5254 | 56.2 |
| 6 | FFS[1] | 0.00 | Decentration(2) | 1.5254 | 56.2 |
| 7 | FFS[3] | 0.00 | Decentration(4) | | |
| 8 | ∞ | 8.07 | Decentration(5) | | |
| 9 | ∞ | 1.10 | | 1.5163 | 64.1 |
| 10 | ∞ | 0.00 | | | |
| Image plane | ∞ | 0.00 | | | |

FFS[1]

| | | | | | |
|---|---|---|---|---|---|
| C4 | −4.2863e−003 | C6 | −1.3959e−003 | C8 | −3.9491e−005 |
| C10 | −1.0646e−004 | C11 | 1.7841e−006 | C13 | 3.3026e−006 |
| C15 | −1.7526e−006 | C17 | −3.4738e−007 | C19 | 2.3458e−007 |
| C21 | −6.3352e−008 | C22 | −2.2115e−009 | C24 | −1.3047e−008 |
| C26 | 6.4137e−009 | C28 | −8.7516e−010 | C30 | 1.3231e−010 |
| C32 | −5.2597e−011 | C34 | 7.0339e−011 | C36 | 5.3328e−011 |

FFS[2]

| | | | | | |
|---|---|---|---|---|---|
| C4 | −7.6464e−003 | C6 | −6.7293e−003 | C8 | −1.3155e−005 |
| C10 | −9.2812e−005 | C11 | 1.8078e−007 | C13 | 1.0283e−006 |
| C15 | 3.2919e−006 | C17 | −1.3339e−007 | C19 | −2.8011e−008 |
| C21 | −1.3364e−007 | C22 | 2.6476e−010 | C24 | 4.1315e−009 |
| C26 | −2.1428e−009 | C28 | 3.3556e−009 | | |

FFS[3]

| | | | | | |
|---|---|---|---|---|---|
| C4 | −1.4606e−002 | C6 | −2.8786e−003 | C8 | 2.0132e−004 |
| C10 | −9.4027e−004 | C11 | 2.1591e−005 | C13 | 3.4944e−005 |
| C15 | −1.2805e−005 | C10 | −2.4519e−006 | C19 | 1.1114e−005 |
| C21 | −1.1433e−005 | C22 | −4.8092e−008 | C24 | −3.4380e−007 |
| C26 | −2.8262e−007 | C28 | 1.3987e−006 | C30 | 6.4424e−009 |
| C32 | 6.4127e−009 | C34 | −1.8332e−009 | C36 | −4.7097e−008 |

Decentration[1]

| | | | | | |
|---|---|---|---|---|---|
| X | 0.00 | Y | 0.00 | Z | 27.00 |
| α | 0.00 | β | 0.00 | γ | 0.00 |

Decentration[2]

| | | | | | |
|---|---|---|---|---|---|
| X | 0.00 | Y | 2.00 | Z | 30.31 |
| α | 14.02 | β | 0.00 | γ | 0.00 |

Decentration[3]

| | | | | | |
|---|---|---|---|---|---|
| X | 0.00 | Y | −4.73 | Z | 37.81 |
| α | −21.43 | β | 0.00 | γ | 0.00 |

Decentration[4]

| | | | | | |
|---|---|---|---|---|---|
| X | 0.00 | Y | 15.48 | Z | 38.18 |
| α | 60.21 | β | 0.00 | y | 0.00 |

Decentration[5]

| | | | | | |
|---|---|---|---|---|---|
| X | 0.00 | Y | 17.77 | Z | 33.73 |
| α | 64.71 | β | 0.00 | γ | 0.00 |

### Example 1 (Direct-Vision Optical Path)

| | | Surface | | Refractive | Abbe |
|---|---|---|---|---|---|
| Surface No. | Radius of curvature | separation | Decentration | index | number |
| Object plane | ∞ | −1000.00 | | | |
| 1 | Stop plane | 0.00 | | | |
| 2 | ∞ | 0.00 | Decentration(1) | 1.5254 | 56.2 |
| 3 | FFS[1] | 0.05 | Decentration(2) | | |
| 4 | FFS[1] | 0.00 | Decentration(2) | 1.5254 | 56.2 |
| 5 | FFS[2] | 0.00 | Decentration(3) | | |
| 6 | FFS[2] | 0.00 | Decentration(3) | 1.5254 | 56.2 |
| 7 | ∞ | 0.00 | Decentration(4) | | |
| 8 | ∞ | 100.00 | | | |
| 9 | Perfect lens | 89.61 | | | |
| Image plane | ∞ | 0.00 | | | |

FFS[1]

| | | | | | |
|---|---|---|---|---|---|
| C4 | −4.2863e−003 | C6 | −1.3959e−003 | C8 | −3.9491e−005 |
| C10 | −1.0646e−004 | C11 | 1.7841e−006 | C13 | 3.3026e−006 |
| C15 | −1.7526e−006 | C10 | −3.4738e−007 | C19 | 2.3458e−007 |
| C21 | −6.3352e−008 | C22 | −2.2115e−009 | C24 | −1.3047e−008 |
| C26 | 6.4137e−009 | C28 | −8.7516e−010 | C30 | 1.3231e−010 |
| C32 | −5.2597e−011 | C34 | 7.0339e−011 | C36 | 5.3328e−011 |

FFS[2]

| | | | | | |
|---|---|---|---|---|---|
| C4 | −7.6464e−003 | C6 | −6.7293e−003 | C8 | −1.3155e−005 |
| C10 | −9.2812e−005 | C11 | 1.8078e−007 | C13 | 1.0283e−006 |
| C15 | 3.2919e−006 | C10 | −1.3339e−007 | C19 | −2.8011e−008 |
| C21 | −1.3364e−007 | C22 | 2.6476e−010 | C24 | 4.1315e−009 |
| C26 | −2.1428e−009 | | | | |

Decentration [1]

| | | | | | |
|---|---|---|---|---|---|
| X | 0.00 | Y | 0.00 | Z | 27.00 |
| α | 0.00 | β | 0.00 | γ | 0.00 |

Decentration [2]

| | | | | | |
|---|---|---|---|---|---|
| X | 0.00 | Y | 2.00 | Z | 30.31 |
| α | 14.02 | β | 0.00 | γ | 0.00 |

Decentration [3]

| | | | | | |
|---|---|---|---|---|---|
| X | 0.00 | Y | −4.73 | Z | 37.81 |
| α | −21.43 | β | 0.00 | γ | 0.00 |

Decentration [4]

| | | | | | |
|---|---|---|---|---|---|
| X | 0.00 | Y | 0.00 | Z | 43.00 |
| α | 0.00 | β | 0.00 | γ | 0.00 |

### Example 2 (Viewing of Electronic Images)

| | | Surface | | Refractive | Abbe |
|---|---|---|---|---|---|
| Surface No. | Radius of curvature | separation | Decentration | index | number |
| Object plane | ∞ | −2000.00 | | | |
| 1 | Stop plane | 0.00 | | | |
| 2 | ∞ | 0.00 | Decentration(1) | 1.5254 | 56.2 |
| 3 | FFS[1] | 0.05 | Decentration(2) | | |
| 4 | FFS[1] | 0.00 | Decentration(2) | 1.5254 | 56.2 |
| 5 | FFS[2] | 0.00 | Decentration(3) | 1.5254 | 56.2 |
| 6 | FFS[1] | 0.00 | Decentration(2) | 1.5254 | 56.2 |
| 7 | FFS[3] | 0.00 | Decentration(4) | | |
| 8 | ∞ | 1.00 | Decentration(5) | | |
| 9 | ∞ | 1.40 | | 1.5254 | 56.2 |
| 10 | Diffractive | 9.20 | | | |
| | surface[1] | | | | |
| 11 | ∞ | 1.10 | | 1.5163 | 64.1 |
| 12 | ∞ | 0.00 | | | |
| Image plane | ∞ | 0.00 | | | |

FFS[1]

| | | | | | |
|---|---|---|---|---|---|
| C4 | −2.4994e−003 | C6 | −7.4348e−005 | C8 | −1.6275e−005 |
| C10 | −4.1818e−005 | C11 | 7.7689e−007 | C13 | −1.7201e−006 |
| C15 | 3.0768e−006 | C17 | −8.3817e−008 | C19 | 5.7713e−008 |
| C21 | −1.2903e−007 | C22 | −4.3804e−011 | C24 | 1.0352e−009 |
| C26 | −1.3970e−009 | C28 | 8.9016e−010 | C30 | 1.0389e−010 |
| C32 | 4.2045e−012 | C34 | 1.0038e−010 | C36 | 2.5564e−011 |

FFS[2]

| | | | | | |
|---|---|---|---|---|---|
| C4 | −5.8445e−003 | C6 | −4.7597e−003 | C8 | −1.2885e−005 |
| C10 | −2.4683e−005 | C11 | 2.1300e−007 | C13 | 1.2206e−006 |
| C15 | 1.7599e−007 | C17 | −4.3260e−008 | C19 | 1.2616e−008 |
| C21 | −6.3515e−009 | C22 | 8.5223e−010 | C24 | 3.2789e−009 |
| C26 | 8.8298e−010 | C28 | 7.7033e−009 | C30 | 1.8234e−011 |
| C32 | −4.6299e−011 | C34 | −6.6938e−011 | C36 | −2.8363e−010 |

FFS[3]

| | | | | | |
|---|---|---|---|---|---|
| C4 | −1.3066e−002 | C6 | −1.8572e−002 | C8 | 7.9275e−004 |
| C10 | 3.6511e−004 | C11 | −3.7518e−006 | C13 | 3.3436e−005 |
| C15 | 3.0838e−005 | C10 | −1.4250e−006 | C19 | 9.3135e−007 |
| C21 | 2.7063e−006 | C22 | 4.0253e−009 | C24 | −3.9068e−008 |
| C26 | −1.3621e−008 | C28 | 2.6593e−008 | C30 | 1.1021e−009 |
| C32 | −2.6400e−010 | C34 | −1.7730e−009 | C36 | −2.5628e−009 |

Decentration[1]

| | | | | | |
|---|---|---|---|---|---|
| X | 0.00 | Y | 0.00 | Z | 27.00 |
| α | 0.00 | β | 0.00 | γ | 0.00 |

Decentration[2]

| | | | | | |
|---|---|---|---|---|---|
| X | 0.00 | Y | −4.85 | Z | 32.04 |
| α | 14.23 | β | 0.00 | γ | 0.00 |

Decentration[3]

| | | | | | |
|---|---|---|---|---|---|
| X | 0.00 | Y | −2.18 | Z | 40.01 |
| α | −17.67 | β | 0.00 | γ | 0.00 |

Decentration[4]

| | | | | | |
|---|---|---|---|---|---|
| X | 0.00 | Y | 22.04 | Z | 30.68 |
| α | 77.37 | β | 0.00 | γ | 0.00 |

Decentration[5]

| | | | | | |
|---|---|---|---|---|---|
| X | 0.00 | Y | 20.46 | Z | 35.45 |
| α | 60.91 | β | 0.00 | γ | 0.00 |

Diffractive surface[1]

| | | |
|---|---|---|
| P2: −1.8010e−03 | P4: 3.9920e−06 | P6: −8.4264e−09 |

### Example 2 (Direct-Vision Optical Path)

| | | Surface | | Refractive | Abbe |
|---|---|---|---|---|---|
| Surface No. | Radius of curvature | separation | Decentration | index | number |
| Object plane | ∞ | −2000.00 | | | |
| 1 | Stop plane | 0.00 | | | |
| 2 | ∞ | 0.00 | Decentration(1) | 1.5254 | 56.2 |
| 3 | FFS[1] | 0.05 | Decentration(2) | | |
| 4 | FFS[1] | 0.00 | Decentration(2) | 1.5254 | 56.2 |
| 5 | FFS[2] | 0.00 | Decentration(3) | | |
| 6 | FFS[2] | 0.00 | Decentration(3) | 1.5254 | 56.2 |
| 7 | ∞ | 0.00 | Decentration(4) | | |
| 8 | ∞ | 100.00 | | | |
| 9 | Perfect lens | 95.02 | | | |
| Image plane | ∞ | 0.00 | | | |

FFS[1]

| | | | | | |
|---|---|---|---|---|---|
| C4 | −2.4994e−003 | C6 | −7.4348e−005 | C8 | −1.6275e−005 |
| C10 | −4.1818e−005 | C11 | 7.7689e−007 | C13 | −1.7201e−006 |
| C15 | 3.0768e−006 | C17 | −8.3817e−008 | C19 | 5.7713e−008 |
| C21 | −1.2903e−007 | C22 | −4.3804e−011 | C24 | 1.0352e−009 |
| C26 | −1.3970e−009 | C28 | 8.9016e−010 | C30 | 1.0389e−010 |
| C32 | 4.2045e−012 | C34 | 1.0038e−010 | C36 | 2.5564e−011 |

FFS[2]

| | | | | | |
|---|---|---|---|---|---|
| C4 | −5.8445e−003 | C6 | −4.7597e−003 | C8 | −1.2885e−005 |
| C10 | −2.4683e−005 | C11 | 2.1300e−007 | C13 | 1.2206e−006 |
| C15 | 1.7599e−007 | C10 | −4.3260e−008 | C19 | 1.2616e−008 |
| C21 | −6.3515e−009 | C22 | 8.5223e−010 | C24 | 3.2789e−009 |
| C26 | 8.8298e−010 | C28 | 7.7033e−009 | C30 | 1.8234e−011 |
| C32 | −4.6299e−011 | C34 | −6.6938e−011 | C36 | −2.8363e−010 |

Decentration [1]

| | | | | | |
|---|---|---|---|---|---|
| X | 0.00 | Y | 0.00 | Z | 27.00 |
| α | 0.00 | β | 0.00 | γ | 0.00 |

Decentration [2]

| | | | | | |
|---|---|---|---|---|---|
| X | 0.00 | Y | −4.85 | Z | 32.04 |
| α | 14.23 | β | 0.00 | γ | 0.00 |

Decentration [3]

| | | | | | |
|---|---|---|---|---|---|
| X | 0.00 | Y | −2.18 | Z | 40.01 |
| α | −17.67 | β | 0.00 | γ | 0.00 |

Decentration [4]

| | | | | | |
|---|---|---|---|---|---|
| X | 0.00 | Y | 0.00 | Z | 45.30 |
| α | 0.00 | β | 0.00 | γ | 0.00 |

### Example 3 (Viewing of Electronic Images)

| | | Surface | | Refractive | Abbe |
|---|---|---|---|---|---|
| Surface No. | Radius of curvature | separation | Decentration | index | number |
| Object plane | ∞ | −1000.00 | | | |
| 1 | Stop plane | 0.00 | | | |
| 2 | Diffractive | 0.00 | Decentration(1) | 1.5254 | 56.2 |
| | surface[1] | | | | |
| 3 | FFS[1] | 0.05 | Decentration(2) | | |
| 4 | FFS[1] | 0.00 | Decentration(2) | 1.5254 | 56.2 |
| 5 | FFS[2] | 0.00 | Decentration(3) | 1.5254 | 56.2 |
| 6 | FFS[1] | 0.00 | Decentration(2) | 1.5254 | 56.2 |
| 7 | FFS[3] | 0.00 | Decentration(4) | | |
| 8 | ∞ | 11.45 | Decentration(5) | | |
| 9 | ∞ | 1.10 | | 1.5163 | 64.1 |
| 10 | ∞ | 0.00 | | | |
| Image plane | ∞ | 0.00 | | | |

FFS[1]

| | | | | | |
|---|---|---|---|---|---|
| C4 | −2.1406e−003 | C6 | 5.8792e−004 | C8 | −5.9741e−005 |
| C10 | −5.8674e−005 | C11 | 2.0872e−006 | C13 | 1.8477e−006 |
| C15 | 1.2982e−006 | C10 | −2.3559e−007 | C19 | −2.0487e−008 |
| C21 | 8.7185e−009 | C22 | 1.0423e−010 | C24 | −1.0526e−008 |
| C26 | 2.8592e−009 | C28 | −8.4148e−009 | C30 | 5.3857e−010 |
| C32 | 6.0293e−010 | C34 | −8.9376e−011 | C36 | 2.6273e−010 |

FFS[2]

| | | | | | |
|---|---|---|---|---|---|
| C4 | −5.7991e−003 | C6 | −4.7242e−003 | C8 | −2.6683e−005 |
| C10 | −7.2210e−005 | C11 | 1.0535e−006 | C13 | 2.9845e−006 |
| C15 | 1.9944e−006 | C10 | −1.5914e−007 | C19 | −9.9972e−008 |
| C21 | −2.0927e−007 | C22 | 2.0063e−009 | C24 | 7.3711e−009 |
| C26 | 4.3437e−009 | C28 | 2.1705e−008 | C30 | 1.1101e−010 |
| C32 | 1.3722e−011 | C34 | −1.0434e−010 | C36 | −5.6626e−010 |

FFS[3]

| | | | | | |
|---|---|---|---|---|---|
| C4 | −2.0078e−002 | C6 | −1.6534e−002 | C8 | 1.4219e−004 |
| C10 | −4.8762e−004 | C11 | 8.6784e−006 | C13 | 4.3244e−005 |
| C15 | −3.1846e−005 | C10 | −1.3482e−006 | C19 | 4.4177e−007 |
| C21 | 1.4790e−006 | C22 | −8.9668e−009 | C24 | −6.9363e−008 |
| C26 | −1.7529e−007 | C28 | 3.2984e−007 | C30 | 2.1599e−009 |
| C32 | 8.6523e−009 | C34 | −4.0534e−009 | C36 | 4.5554e−009 |

Decentration[1]

| | | | | | |
|---|---|---|---|---|---|
| X | 0.00 | Y | 0.00 | Z | 22.84 |
| α | 0.00 | β | 0.00 | γ | 0.00 |

Decentration[2]

| | | | | | |
|---|---|---|---|---|---|
| X | 0.00 | Y | −4.19 | Z | 27.82 |
| α | 15.74 | β | 0.00 | γ | 0.00 |

Decentration[3]

| | | | | | |
|---|---|---|---|---|---|
| X | 0.00 | Y | −4.38 | Z | 33.51 |
| α | −18.97 | β | 0.00 | γ | 0.00 |

Decentration[4]

| | | | | | |
|---|---|---|---|---|---|
| X | 0.00 | Y | 17.20 | Z | 31.54 |
| α | 64.13 | β | 0.00 | γ | 0.00 |

Decentration[5]

| | | | | | |
|---|---|---|---|---|---|
| X | 0.00 | Y | 17.79 | Z | 30.22 |
| α | 63.37 | β | 0.00 | γ | 0.00 |

Diffractive surface[1]

| | |
|---|---|
| P2: −4.7267e−04 | P4: 7.2787e−08 |

### Example 3 (Direct-Vision Optical Path)

| | | Surface | | Refractive | Abbe |
|---|---|---|---|---|---|
| Surface No. | Radius of curvature | separation | Decentration | index | number |
| Object plane | ∞ | −1000.00 | | | |
| 1 | Stop plane | 0.00 | | | |
| 2 | Diffractive | 0.00 | Decentration(1) | 1.5254 | 56.2 |
| | surface[1] | | | | |
| 3 | FFS[1] | 0.05 | Decentration(2) | | |
| 4 | FFS[1] | 0.00 | Decentration(2) | 1.5254 | 56.2 |
| 5 | FFS[2] | 0.00 | Decentration(3) | | |
| 6 | FFS[2] | 0.00 | Decentration(3) | 1.5254 | 56.2 |
| 7 | ∞ | 0.00 | Decentration(4) | | |
| 8 | ∞ | 100.00 | | | |
| 9 | Perfect lens | 90.91 | | | |
| Image plane | ∞ | 0.00 | | | |

FFS[1]

| | | | | | |
|---|---|---|---|---|---|
| C4 | −2.1406e−003 | C6 | 5.8792e−004 | C8 | −5.9741e−005 |
| C10 | −5.8674e−005 | C11 | 2.0872e−006 | C13 | 1.8477e−006 |
| C15 | 1.2982e−006 | C10 | −2.3559e−007 | C19 | −2.0487e−008 |
| C21 | 8.7185e−009 | C22 | 1.0423e−010 | C24 | −1.0526e−008 |
| C26 | 2.8592e−009 | C28 | −8.4148e−009 | C30 | 5.3857e−010 |
| C32 | 6.0293e−010 | C34 | −8.9376e−011 | C36 | 2.6273e−010 |

FFS[2]

| | | | | | |
|---|---|---|---|---|---|
| C4 | −5.7991e−003 | C6 | −4.7242e−003 | C8 | −2.6683e−005 |
| C10 | −7.2210e−005 | C11 | 1.0535e−006 | C13 | 2.9845e−006 |
| C15 | 1.9944e−006 | C10 | −1.5914e−007 | C19 | −9.9972e−008 |
| C21 | −2.0927e−007 | C22 | 2.0063e−009 | C24 | 7.3711e−009 |
| C26 | 4.3437e−009 | C28 | 2.1705e−008 | C30 | 1.1101e−010 |
| C32 | 1.3722e−011 | C34 | −1.0434e−010 | C36 | −5.6626e−010 |

Decentration [1]

| | | | | | |
|---|---|---|---|---|---|
| X | 0.00 | Y | 0.00 | Z | 22.84 |
| α | 0.00 | β | 0.00 | γ | 0.00 |

Decentration [2]

| | | | | | |
|---|---|---|---|---|---|
| X | 0.00 | Y | −4.19 | Z | 27.82 |
| α | 15.74 | β | 0.00 | γ | 0.00 |

Decentration [3]

| | | | | | |
|---|---|---|---|---|---|
| X | 0.00 | Y | −4.38 | Z | 33.51 |
| α | −18.97 | β | 0.00 | γ | 0.00 |

Decentration [4]

| | | | | | |
|---|---|---|---|---|---|
| X | 0.00 | Y | 0.00 | Z | 41.32 |
| α | 0.00 | β | 0.00 | γ | 0.00 |

Diffractive surface[1]

| | |
|---|---|
| P2: −4.7267e−04 | P4: 7.2787e−08 |

Diffractive surface[2]

| | |
|---|---|
| P2: 5.3652e−04 | P4: −9.6322e−08 |

### Example 4 (Viewing of Electronic Images)

| | | Surface | | Refractive | Abbe |
|---|---|---|---|---|---|
| Surface No. | Radius of curvature | separation | Decentration | index | number |
| Object plane | ∞ | −2000.00 | | | |
| 1 | Stop plane | 0.00 | | | |
| 2 | ∞ | 0.00 | Decentration(1) | 1.5254 | 56.2 |
| 3 | FFS[1] | 0.05 | Decentration(2) | | |
| 4 | FFS[1] | 0.00 | Decentration(2) | 1.5254 | 56.2 |
| 5 | FFS[2] | 0.00 | Decentration(3) | 1.5254 | 56.2 |
| 6 | FFS[1] | 0.00 | Decentration(2) | 1.5254 | 56.2 |
| 7 | FFS[3] | 0.00 | Decentration(4) | | |
| 8 | ∞ | 1.00 | Decentration(5) | | |
| 9 | ∞ | 1.40 | | 1.7331 | 48.9 |
| 10 | Diffractive | 0.01 | | 1.5839 | 30.2 |
| | surface[1] | | | | |
| 11 | ∞ | 9.20 | | | |
| 12 | ∞ | 1.10 | | 1.5163 | 64.1 |
| 13 | ∞ | 0.00 | | | |
| Image plane | ∞ | 0.00 | | | |

FFS[1]

| | | | | | |
|---|---|---|---|---|---|
| C4 | −2.9115e−003 | C6 | −7.5330e−005 | C8 | −1.0606e−006 |
| C10 | −4.5703e−005 | C11 | 1.1273e−006 | C13 | −2.8994e−006 |
| C15 | 2.8997e−006 | C17 | −1.4190e−007 | C19 | 6.3776e−008 |
| C21 | −1.2740e−007 | C22 | 6.0481e−011 | C24 | 4.4652e−009 |
| C26 | −1.5146e−010 | C28 | 7.1438e−010 | C30 | 5.5080e−011 |
| C32 | −2.7545e−011 | C34 | 9.6825e−011 | C36 | 3.5293e−011 |

FFS[2]

| | | | | | |
|---|---|---|---|---|---|
| C4 | −6.1023e−003 | C6 | −5.0647e−003 | C8 | −1.4210e−005 |
| C10 | −3.2754e−005 | C11 | 1.8585e−007 | C13 | 1.1720e−006 |
| C15 | 7.9267e−007 | C10 | −4.9506e−008 | C19 | 3.1952e−008 |
| C21 | 1.9647e−009 | C22 | 1.0437e−009 | C24 | 5.9020e−009 |
| C26 | 5.8321e−010 | C28 | 6.7480e−009 | C30 | 2.7311e−012 |
| C32 | −1.6257e−010 | C34 | −5.9592e−011 | C36 | −2.8335e−010 |

FFS[3]

| | | | | | |
|---|---|---|---|---|---|
| C4 | −1.1853e−002 | C6 | −1.9751e−002 | C8 | 7.6282e−004 |
| C10 | 3.6930e−004 | C11 | −5.3533e−006 | C13 | 4.1536e−005 |
| C15 | 4.7303e−005 | C10 | −1.1901e−006 | C19 | 1.8677e−006 |
| C21 | 3.3394e−006 | C22 | 3.1796e−009 | C24 | −4.0130e−008 |
| C26 | −1.7468e−008 | C28 | 2.9978e−009 | C30 | 6.1395e−010 |
| C32 | −1.0933e−009 | C34 | −3.0620e−009 | C36 | −4.2073e−009 |

Decentration[1]

| | | | | | |
|---|---|---|---|---|---|
| X | 0.00 | Y | 0.00 | Z | 26.28 |
| α | 0.00 | β | 0.00 | γ | 0.00 |

Decentration[2]

| | | | | | |
|---|---|---|---|---|---|
| X | 0.00 | Y | −4.85 | Z | 31.32 |
| α | 14.26 | β | 0.00 | γ | 0.00 |

Decentration[3]

| | | | | | |
|---|---|---|---|---|---|
| X | 0.00 | Y | −1.85 | Z | 39.12 |
| α | −17.74 | β | 0.00 | γ | 0.00 |

Decentration[4]

| | | | | | |
|---|---|---|---|---|---|
| X | 0.00 | Y | 21.73 | Z | 30.28 |
| α | 75.71 | β | 0.00 | γ | 0.00 |

Decentration[5]

| | | | | | |
|---|---|---|---|---|---|
| X | 0.00 | Y | 20.26 | Z | 34.43 |
| α | 62.42 | β | 0.00 | γ | 0.00 |

Diffractive surface[1]

| | | |
|---|---|---|
| P2 : −1.8385e−03 | P4: 3.8537e−06 | P6: −1.2947e−08 |

### Example 4 (Direct-Vision Optical Path)

| | | Surface | | Refractive | Abbe |
|---|---|---|---|---|---|
| Surface No. | Radius of curvature | separation | Decentration | index | number |
| Object plane | ∞ | −2000.00 | | | |
| 1 | Stop plane | 0.00 | | | |
| 2 | ∞ | 0.00 | Decentration(1) | 1.5254 | 56.2 |
| 3 | FFS[1] | 0.05 | Decentration(2) | | |
| 4 | FFS[1] | 0.00 | Decentration(2) | 1.5254 | 56.2 |
| 5 | FFS[2] | 0.00 | Decentration(3) | | |
| 6 | FFS[2] | 0.00 | Decentration(3) | 1.5254 | 56.2 |
| 7 | ∞ | 0.00 | Decentration(4) | | |
| 8 | ∞ | 100.00 | | | |
| 9 | ∞ | 94.90 | | | |
| Image plane | ∞ | 0.00 | | | |

FFS[1]

| | | | | | |
|---|---|---|---|---|---|
| C4 | −2.9115e−003 | C6 | −7.5330e−005 | C8 | −1.0606e−006 |
| C10 | −4.5703e−005 | C11 | 1.1273e−006 | C13 | −2.8994e−006 |
| C15 | 2.8997e−006 | C10 | −1.4190e−007 | C19 | 6.3776e−008 |
| C21 | −1.2740e−007 | C22 | 6.0481e−011 | C24 | 4.4652e−009 |
| C26 | −1.5146e−010 | C28 | 7.1438e−010 | C30 | 5.5080e−011 |
| C32 | −2.7545e−011 | C34 | 9.6825e−011 | C36 | 3.5293e−011 |

FFS[2]

| | | | | | |
|---|---|---|---|---|---|
| C4 | −6.1023e−003 | C6 | −5.0647e−003 | C8 | −1.4210e−005 |
| C10 | −3.2754e−005 | C11 | 1.8585e−007 | C13 | 1.1720e−006 |
| C15 | 7.9267e−007 | C10 | −4.9506e−008 | C19 | 3.1952e−008 |
| C21 | 1.9647e−009 | C22 | 1.0437e−009 | C24 | 5.9020e−009 |
| C26 | 5.8321e−010 | C28 | 6.7480e−009 | C30 | 2.7311e−012 |
| C32 | −1.6257e−010 | C34 | −5.9592e−011 | C36 | −2.8335e−010 |

Decentration [1]

| | | | | | |
|---|---|---|---|---|---|
| X | 0.00 | Y | 0.00 | Z | 26.28 |
| α | 0.00 | β | 0.00 | γ | 0.00 |

Decentration [2]

| | | | | | |
|---|---|---|---|---|---|
| X | 0.00 | Y | 4.85 | Z | 31.32 |
| α | 14.26 | β | 0.00 | γ | 0.00 |

Decentration [3]

| | | | | | |
|---|---|---|---|---|---|
| X | 0.00 | Y | −1.85 | Z | 39.12 |
| α | −17.74 | β | 0.00 | γ | 0.00 |

Decentration [4]

| | | | | | |
|---|---|---|---|---|---|
| X | 0.00 | Y | 0.00 | Z | 45.00 |
| α | 0.00 | β | 0.00 | γ | 0.00 |

In Examples 1 to 4 described here, Condition (1) has the following values.

| | Ex. 1 | Ex. 2 | Ex. 3 | Ex. 4 |
|---|---|---|---|---|
| φ g (X) | 0 | 0 | 0.00002 | 0 |
| φ g (Y) | 0 | 0 | 0.00001 | 0 |

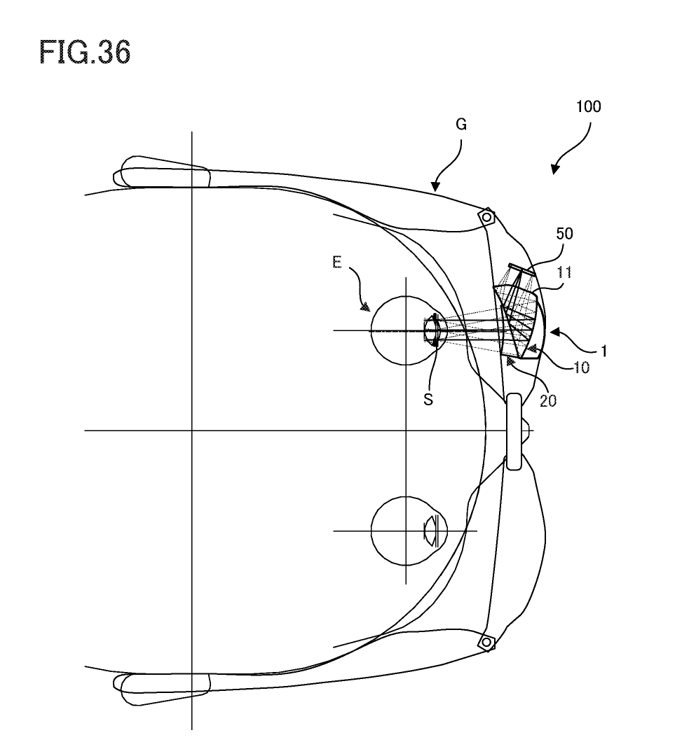

FIG. 36 is illustrative of an image projector apparatus 100 having the decentered optical system 1 described here built in eyeglasses G.

The image projector apparatus 100 described here includes the decentered optical system 1 described above, and an image display device 50 that is located on the object plane opposite to the first surface 11 of the first optical element 10 to display images. Albeit having a small-format size and simple structure, this apparatus could be used to project images at higher resolution than ever before.

Although the present invention has been described with reference to various embodiments, it is to be appreciated that it is not limited to them; embodiments obtained in combinations of arrangements could also be encompassed in the category of the invention.

### REFERENCE SIGNS LIST

1: Decentered optical system
50: Image display device (in the case of the image projector apparatus, and image-taking device (in the case of the image-taking apparatus)
10: First optical element
20: Second optical element
30: Third optical element
Im: Image plane (image display plane in the case of the image projector apparatus, and imaging plane in the case of the image-taking apparatus)
S: Aperture stop
60: Diffractive optical surface

1. A decentered optical system comprising:
a first optical element having at least three mutually decentered optical surfaces: a first surface capable of light transmission, a second surface capable of light transmission and internal reflection, and a third surface capable of light transmission and internal reflection, and filled inside with a medium having a refractive index of greater than 1, at least one of the three optical surfaces being configured into a rotationally asymmetric shape,
a second optical element having at least two mutually decentered optical surfaces: a first surface that is capable of light transmission and located facing the first optical element and a second surface that is capable of light transmission, located in opposition to the first optical element and defined by a plane, and filled inside with a medium having a refractive index of greater than 1, the second optical element being located on a second surface side of the first optical element, and
a third optical element having at least two mutually decentered optical surfaces: a first surface that is capable of light transmission, located in opposition to the first optical element and defined by a plane, and a second surface that is capable of light transmission and cemented to the third surface of the first optical element, and filled inside with a medium having a refractive index of greater than 1.

2. The decentered optical system according to claim 1, further comprising
a diffractive optical surface in an optical path taken from an object plane to an image plane.

3. The decentered optical system according to claim 2, wherein
the diffractive optical surface is placed on the outside of the first surface of the first optical element.

4. The decentered optical system according to claim 2,
wherein the diffractive optical surface is formed by lamination of a plurality of optical members having different refractive indices.

5. The decentered optical system according to claim 2,
wherein the diffractive optical surface is formed on the second surface of the second optical element.

6. The decentered optical system according to claim 1,
wherein the second surface of the first optical element is spaced away from the first surface of the second optical element.

7. The decentered optical system according to claim 1,
wherein the second surface of the first optical element and the first surface of the second optical element are of the same surface configuration in an effective area.

8. The decentered optical system according to claim 1,
wherein the second surface of the first optical element is a rotationally asymmetric surface.

9. The decentered optical system according to claim 1,
wherein the refracting power φg of the whole optical system with respect to a center chief ray incident on the first surface of the third optical element satisfies the following condition (1):
−0.05 mm⁻¹φg<0.05 mm⁻¹ (1)

10. The decentered optical system according to claim 1,
wherein the third surface of the first optical element has a rotationally asymmetrical surface.

11. An image projector apparatus comprising:
a decentered optical system according to claim 1, and
an image display device that is located in a position in opposition to the first surface of the first optical element.
